(19) United States
(12) Patent Application Publication
(10) Pub. No.: US 2016/0071286 A1
(43) Pub. Date: Mar. 10, 2016

(54) IMAGE PROCESSING APPARATUS, IMAGING APPARATUS, CONTROL METHOD, AND STORAGE MEDIUM

(71) Applicant: CANON KABUSHIKI KAISHA, Tokyo (JP)

(72) Inventors: Masahiro Kawarada, Tokyo (JP); Reiji Hasegawa, Kawasaki-shi (JP); Kenichiro Amano, Tokyo (JP)

(21) Appl. No.: 14/846,516

(22) Filed: Sep. 4, 2015

(30) Foreign Application Priority Data
Sep. 9, 2014 (JP) 2014-183341

(51) Int. Cl. G06T 7/20; H04N 9/04; G05B 15/02

(52) U.S. Cl. CPC G06T 7/208; G05B 15/02; G06T 7/2046; H04N 9/045; G06T 2207/10024; G06T 2207/30244; G06T 2207/20024

(57) ABSTRACT

To increase the accuracy of object tracking using particle filter processing, an imaging apparatus performs object tracking processing as follows. During an SW1 holding state and continuous shooting, the apparatus repeatedly performs distributing particles according to the random number following normal distribution based on light metering image data obtained from an AE sensor, estimating an image region of an object by calculating likelihood at the position of each of the particles, and arranging a particle having a lower likelihood in the position of a particle having a higher likelihood. At this time, the apparatus calculates a movement amount of the object based on a difference between the present position of the object and the previous position thereof. If the calculated movement amount is greater than a predetermined threshold value, the apparatus increases the dispersion of the normal distribution for random movement of the particles to be performed next.

### BACKGROUND

1. Technical Field

The present disclosure relates to an image processing apparatus that performs object tracking using particle filter processing, an imaging apparatus, an image processing method, and a storage medium.

2. Description of the Related Art

Conventionally, there is known an object tracking apparatus for tracking a target object using particle filter processing, as described in Tomoyuki Higuchi's “Explanation of Particle filter”, The Journal of the Institute of Electronics, Information and Communication Engineers (J. IEICE), Vol. 88 No. 12, pp. 989-994, December 2005, and Hironobu Fujiyoshi's “Moving image understanding technique and application thereof”, Department of Information Engineering, College of Engineering, Chubu University (see http://www.vision.cs.chubu.ac.jp/VU/pdf/VU.pdf). The particle filter processing includes distributing a finite number of particles, sampling pixels of an object image where the particles are arranged, and then performing calculation to obtain likelihood based on feature amounts time-sequentially acquired. The particle filter processing can be used to estimate the position of a target object based on the level of likelihood. The position and movement of the target object can be detected based on the position of a particle having a higher likelihood and a weighting factor thereof.

Regarding the above-described object tracking using the particle filter processing, Japanese Patent Application Laid-Open No. 2009-188977 discusses a target tracking apparatus capable of performing particle filter processing while changing information about a characteristic color of a tracking target object based on a color change at a position other than a region of the tracking target object.

Further, Japanese Patent Application Laid-Open No. 2012-203439 discusses a configuration for predicting the next position and shape of a recognized object and recognizing the recognized object having the predicted shape in a region of an image corresponding to the predicted position. Further, Japanese Patent Application Laid-Open No. 2010-193333 discusses a configuration including an imaging unit configured to time-sequentially capture a plurality of images within a predetermined angle of view, a detection unit configured to detect a human object from the plurality of images, and a tracking unit configured to specify a human head (hair) portion as a target area and track the target area.

The object tracking method using particle filter processing is advantageous in that calculation load is relatively light, compared to a template matching method in which an object is tracked while being compared with a reference image thereof in the tracking range of an input image. Further, the object tracking method has excellent robustness and can acquire the feature amount of the object as an aggregate even when the shape of the object changes.

However, in the particle filter processing, the feature amount cannot be sufficiently acquired unless the particles are appropriately applied to a target object. For example, in a case where the target object has suddenly and greatly moved or is moving at a high speed, the particles may be distributed to an area in which the object does not exist if the particles are distributed based on only the pre-movement position of the object. As a result, there arises a possibility that a change of the position of the object cannot be appropriately detected.

### SUMMARY

The present disclosure is directed to a technique for enhancing the accuracy of object tracking using particle filter processing.

According to an aspect of the present invention, an image processing apparatus includes an object tracking unit configured to use particle filter processing to perform object tracking processing in which the object tracking unit repeatedly performs distributing particles on an image, calculating an evaluation value at a position of each of the particles to estimate an image region of an object, and arranging a particle having a lower evaluation value in a position of a particle having a higher evaluation value. Further, the object tracking unit is configured to change a way of distributing the particles according to a change in the object or a state of an imaging apparatus having captured the image.

Further features of the present invention will become apparent from the following description of exemplary embodiments with reference to the attached drawings.

### BRIEF DESCRIPTION OF THE DRAWINGS

FIG. 1 is a cross-sectional view illustrating an imaging apparatus according to a first exemplary embodiment.

FIG. 2 illustrates a configuration of the imaging apparatus according to the first exemplary embodiment.

FIG. 3 illustrates an arrangement of distance measurement points.

FIG. 4 is a flowchart illustrating an image-capturing operation performed by the imaging apparatus according to the first exemplary embodiment.

FIG. 5 is a flowchart illustrating object tracking processing according to the first exemplary embodiment.

FIG. 6A illustrates an initial arrangement of particles in particle filter processing, FIG. 6B illustrates updated light metering image data, FIG. 6C illustrates a state of each particle having been randomly moved, FIG. 6D illustrates particles having a higher likelihood, and FIG. 6E illustrates re-sampling of the particles.

FIG. 7, which includes FIGS. 7A and 7B, is a flowchart illustrating object tracking processing according to a second exemplary embodiment.

FIG. 8 is a flowchart illustrating object tracking processing according to a third exemplary embodiment.

FIG. 9 is a cross-sectional view illustrating an imaging apparatus according to a fourth exemplary embodiment.

FIG. 10 is a flowchart illustrating object tracking processing according to the fourth exemplary embodiment.

FIG. 11 illustrates a configuration of an imaging apparatus according to a fifth exemplary embodiment.

FIG. 12 is a flowchart illustrating object tracking processing according to the fifth exemplary embodiment.

FIG. 13 is a flowchart illustrating object tracking processing according to a sixth exemplary embodiment.

FIG. 14 illustrates a configuration of an imaging apparatus according to a seventh exemplary embodiment.

FIG. 15A illustrates a horizontally positioned imaging apparatus and FIG. 15B illustrates a vertically positioned imaging apparatus.

FIG. 16 is a flowchart illustrating object tracking processing according to the seventh exemplary embodiment.

FIG. 17A illustrates dispersion of normal distribution in a case where the imaging apparatus according to the seventh exemplary embodiment is horizontally positioned, and FIG. 17B illustrates dispersion of normal distribution in a case where the imaging apparatus according to the seventh exemplary embodiment is vertically positioned.

FIG. 18 illustrates a configuration of an imaging apparatus according to an eighth exemplary embodiment.

FIG. 19 is a flowchart illustrating processing for randomly moving the particles according to the eighth exemplary embodiment.

FIG. 20A illustrates a state where a particle overlaps with a defective pixel in the eighth exemplary embodiment, and FIG. 20B illustrates relocation of a particle according to the eighth exemplary embodiment.

FIG. 21 is a flowchart illustrating a modification example of the processing for randomly moving the particles according to the eighth exemplary embodiment.

### DESCRIPTION OF THE EMBODIMENTS

Hereinafter, exemplary embodiments of the present invention will be described in detail below with reference to the attached drawings.

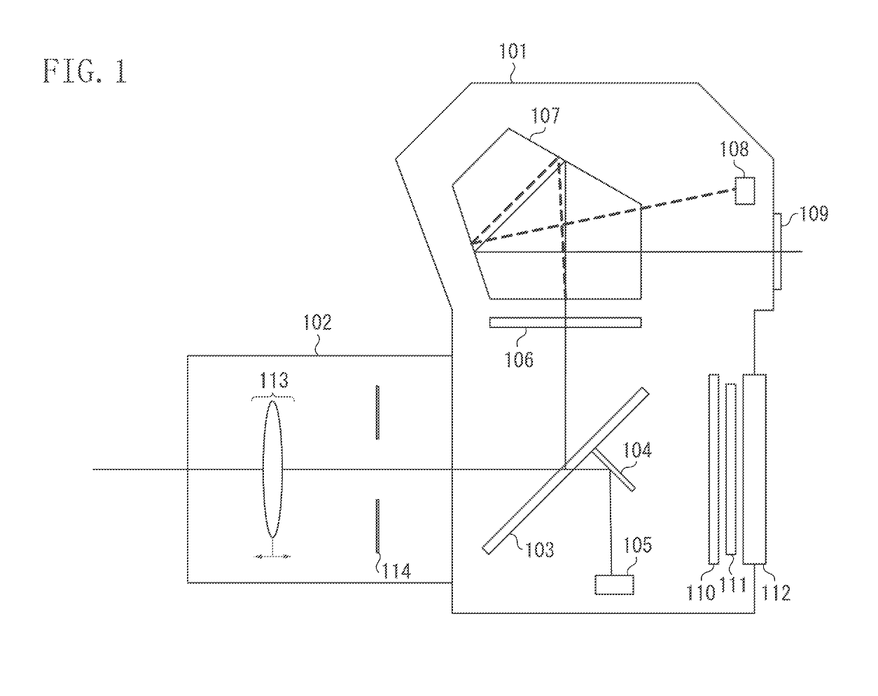

FIG. 1 is a cross-sectional view illustrating a digital single-lens reflex camera as an example of an imaging apparatus according to a first exemplary embodiment.

An interchangeable lens 102 is attached to the front surface of a camera body 101. The camera body 101 and the interchangeable lens 102 are electrically connected to each other via a group of mount contacts (not illustrated). The interchangeable lens 102 includes a focus lens 113 and a diaphragm 114, and can adjust the focus by adjusting the quantity of light that enters the camera body 101 under the control via the group of mount contacts.

A main mirror 103 and a sub mirror 104 are constituted by half mirrors. The main mirror 103 is positioned obliquely on an imaging optical path in a viewfinder observation state, so that the main mirror 103 can reflect an imaging light flux from the interchangeable lens 102 toward a viewfinder optical system. On the other hand, the transmitted light enters an automatic focusing (AF) unit 105 via the sub mirror 104. The AF unit 105 can perform a phase difference detection type AF operation.

A focusing screen 106 is disposed on an expected image formation plane of the interchangeable lens 102 that constitutes the viewfinder optical system. A photographer can check an image-capturing screen by observing the focusing screen 106 from an eyepiece 109 via a pentagonal prism 107 that changes a viewfinder optical path. Control to be performed by an automatic exposure (AE) unit 108 will be described in detail below.

In a case where an exposure operation is performed, both the main mirror 103 and the sub mirror 104 are retracted from the imaging optical path, and an image sensor 111 is exposed to light when a focal plane shutter 110 is opened. Further, a display unit 112 can display shooting information and a captured image.

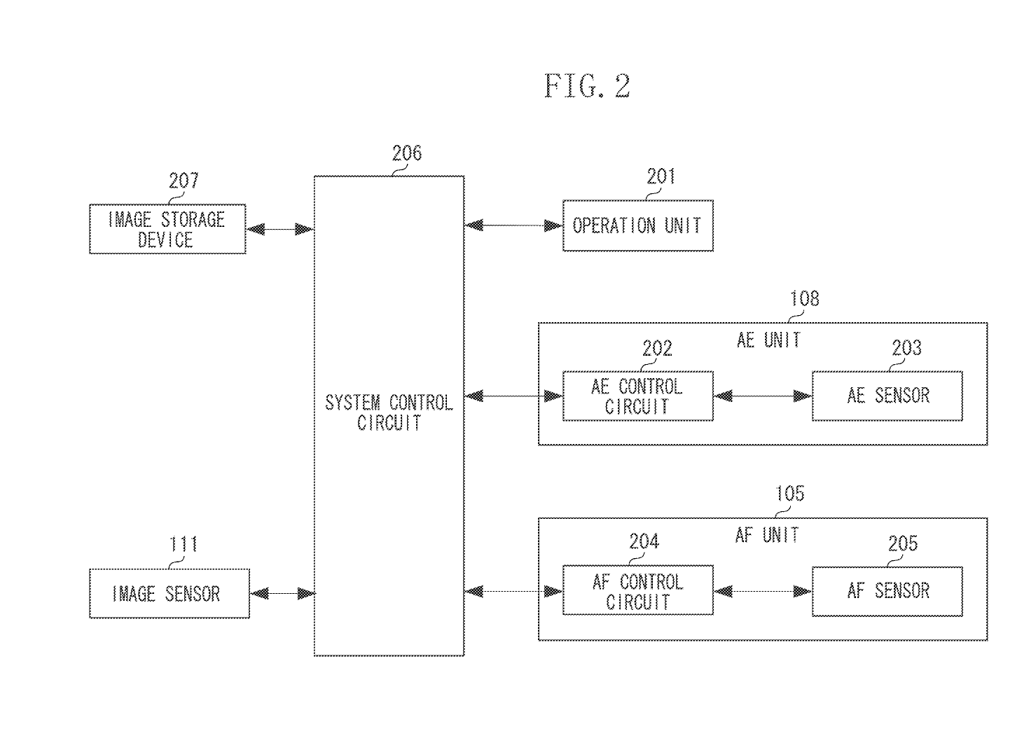

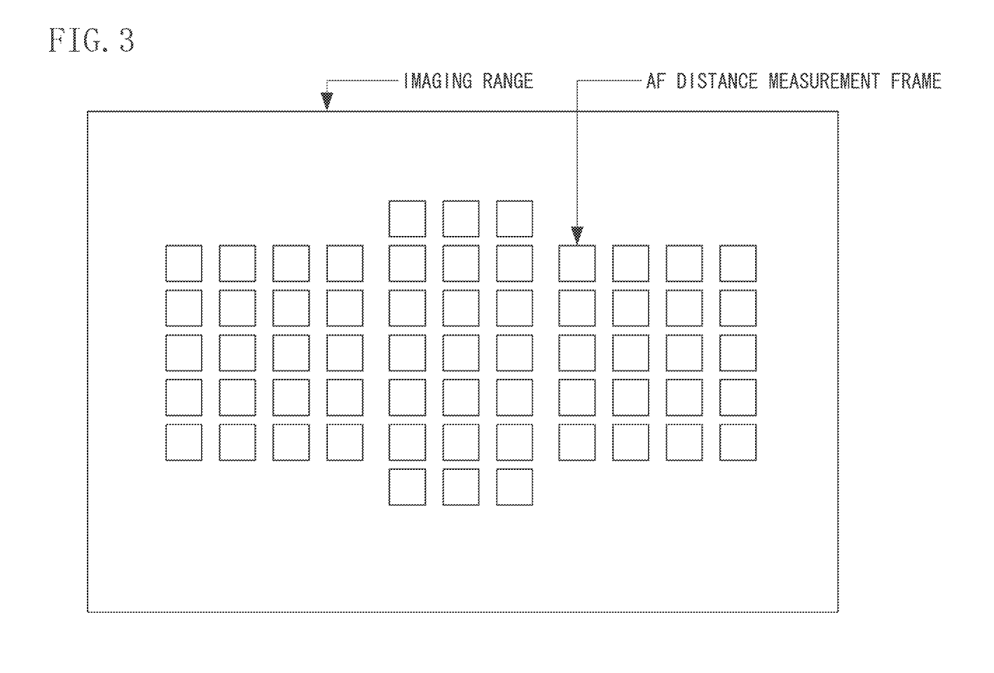

FIG. 2 illustrates a configuration of the imaging apparatus according to the first exemplary embodiment. Constituent components similar to those illustrated in FIG. 1 are denoted by the same reference numerals.

An operation unit 201 is constituted by various buttons, switches, a dial, and a connection device, which are not illustrated. The operation unit 201 detects an operation performed by a photographer via these components, and transmits a signal corresponding to the content of the operation to a system control circuit 206. The operation unit 201 includes a release button (not illustrated). The release button is a two-stage stroke type, and outputs to the system control circuit 206 an SW1 signal at the moment when the release button is pressed up to a first stage (is half-pressed) and an SW2 signal at the moment when the release button is pressed up to a second stage (is fully pressed). The state where the release button is held by the photographer at the half-pressed state is referred to as an SW1 holding state. The state where the release button is held by the photographer at the fully pressed state is referred to as an SW2 holding state. Further, the operation unit 201 outputs to the system control circuit 206 an SW1 release signal at the moment when the release button is released by the photographer in the SW1 holding state and an SW2 release signal at the moment when the release button is released by the photographer in the SW2 holding state.

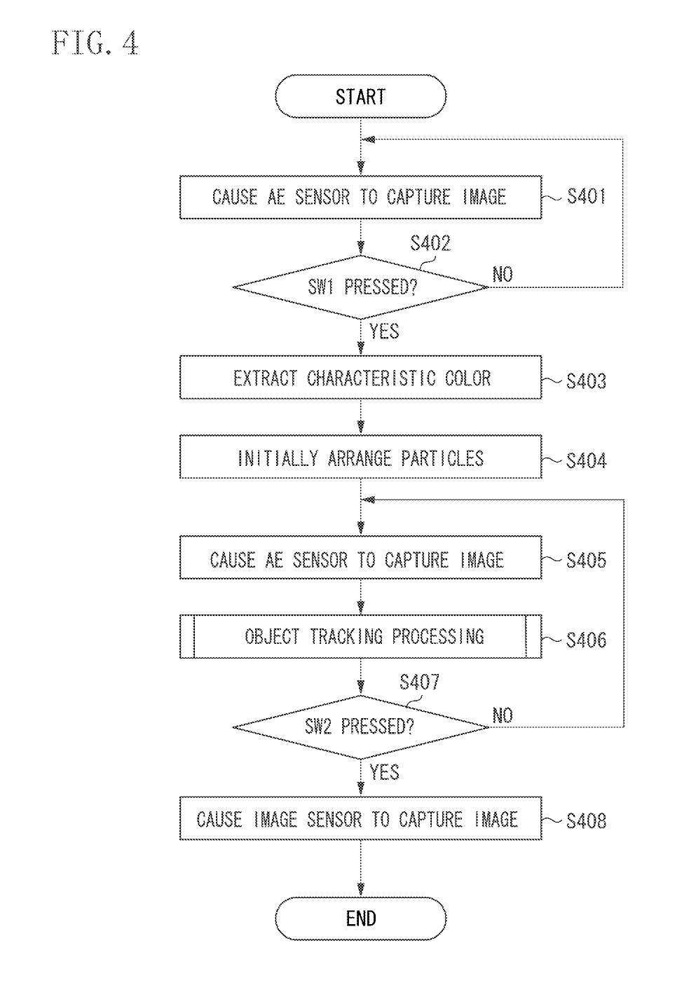

The AF unit 105 is configured to perform auto-focus detection processing. The AF unit 105 includes an AF control circuit 204 and an AF sensor 205. The AF sensor 205 is constituted by pairs of line sensors corresponding to the arrangement of 61 AF distance measurement frames (distance measurement points) as illustrated in FIG. 3. The AF sensor 205 converts light, which is incident thereon via the sub mirror 104, into an electric signal and outputs an image signal to the AF control circuit 204. The AF control circuit 204 calculates a defocus amount of the AF distance measurement frame corresponding to each of the pairs of line sensors illustrated in FIG. 3, based on phase difference between a corresponding pair of image signals output from the AF sensor 205. The AF control circuit 204 selects one of the AF distance measurement frames to be subjected to focus adjustment. Then, the AF control circuit 204 outputs a defocus map (i.e., data indicating the defocus amount of each of the AF distance measurement frames) and position information of the selected AF distance measurement frame to the system control circuit 206.

The system control circuit 206 performs focus adjustment calculation based on the position of the selected AF distance measurement frame and the defocus map. The system control circuit 206 detects a focus adjustment state of the interchangeable lens 102 and, based on the detection result, performs automatic focus adjustment by driving the focus lens 113.

The AE unit 108 is configured to perform automatic exposure calculation. The AE unit 108 includes an AE control circuit 202 and an AE sensor 203. The AE control circuit 202 performs automatic exposure calculation based on light metering image data read from the AE sensor 203 having several tens thousands of pixels, and outputs the calculation result to the system control circuit 206.

The system control circuit 206 controls the aperture of the diaphragm 114 based on the automatic exposure calculation result output from the AE control circuit 202 and adjusts the quantity of light to enter the camera body 101. Further, the system control circuit 206 controls the focal plane shutter 110 in a release operation to adjust exposure time of the image sensor 111.

Further, during the SW1 holding state and continuous shooting, the system control circuit 206 performs object tracking processing by using the light metering image data obtained from the AE sensor 203. The object tracking processing will be described in detail below. The system control circuit 206 outputs position data of the tracking target to the AF control circuit 204. Although the system control circuit 206 performs the object tracking processing in the present exemplary embodiment, the AE control circuit 202 may be configured to perform the object tracking processing.

The system control circuit 206 controls the main mirror 103, the sub mirror 104, and the focal plane shutter 110 based on the signal output from the operation unit 201. If the signal output from the operation unit 201 is the SW2 signal, the system control circuit 206 moves the main mirror 103 and the sub mirror 104 to a first mirror position in which the main mirror 103 and the sub mirror 104 are retracted to the outside of an imaging optical system leading to the image sensor 111, and controls the focal plane shutter 110 so that the image sensor 111 is irradiated with light. When the control for the focal plane shutter 110 is completed, the system control circuit 206 returns the main mirror 103 and the sub mirror 104 to a second mirror position so as to divide the optical path of the imaging optical system. FIG. 1 illustrates the configuration in which the main mirror 103 and the sub mirror 104 are in the second mirror position.

The image sensor 111 includes several millions to several tens of millions of pixels. The image sensor 111 converts light incident thereon through the interchangeable lens 102 into an electric signal to generate image data, and then outputs the generated image data to the system control circuit 206. The system control circuit 206 causes the display unit 112 to display the image data that is output from the image sensor 111 and writes the image data into an image storage device 207.

FIG. 4 is a flowchart illustrating an image-capturing operation to be performed by the imaging apparatus according to the first exemplary embodiment. Unless otherwise described, the system control circuit 206 controls the operation illustrated in FIG. 4.

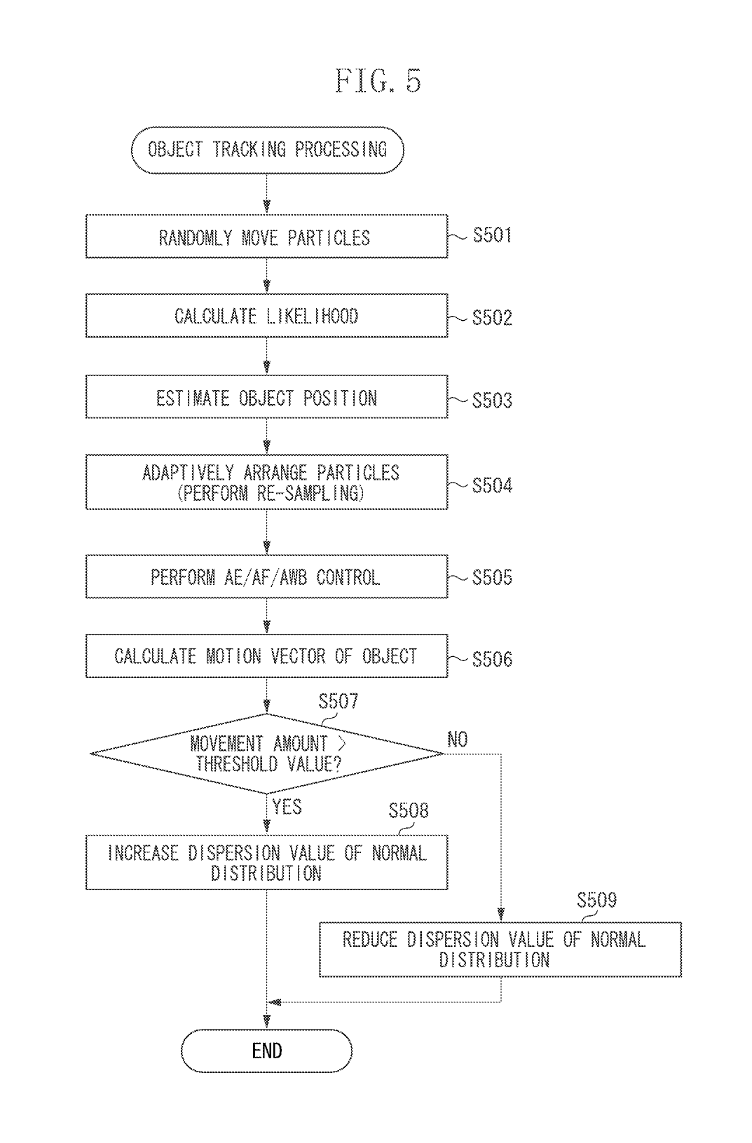

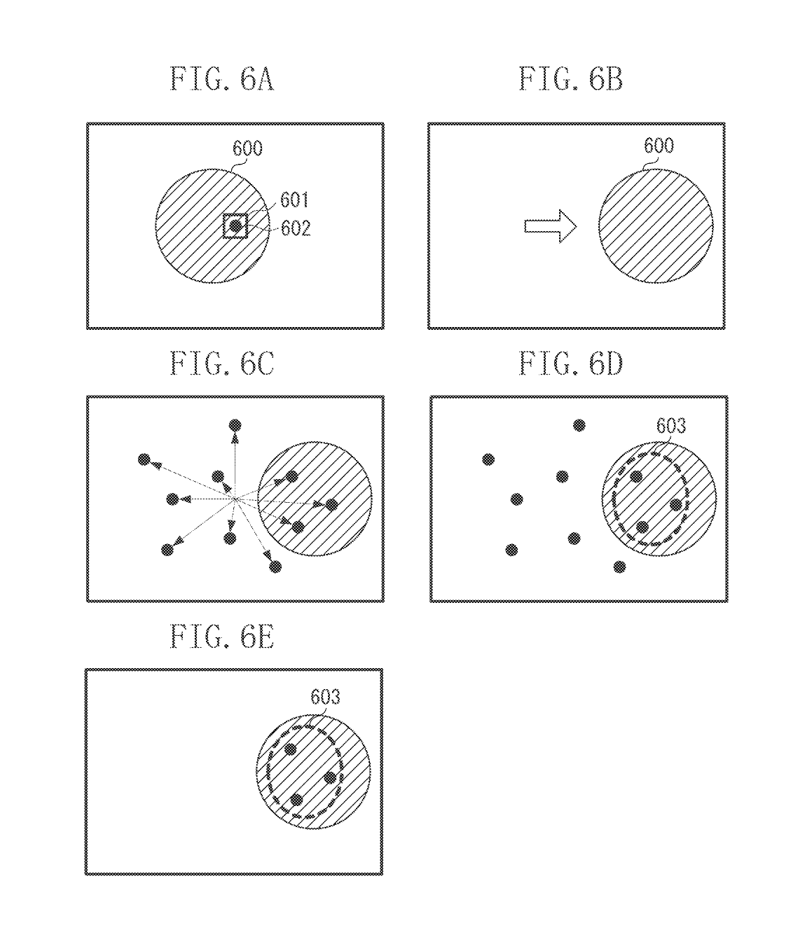

In step S401, the AE unit 108 performs an image-capturing operation and obtains light metering image data. FIG. 6A illustrates an example of the light metering image data obtained in this step. The example includes an object 600.

In step S402, the system control circuit 206 determines whether the SW1 signal has been output in response to the release button (not illustrated) being pressed. If the system control circuit 206 determines that the SW1 signal has not been output (NO in step S402), the operation returns to step S401. If the system control circuit 206 determines that the SW1 signal has been output (YES in step S402), the operation proceeds to step S403.

In step S403, the system control circuit 206 recognizes an object positioned at the center of the light metering image data obtained in step S401 as an object to be tracked hereafter, and extracts a characteristic color of the recognized object. The system control circuit 206 stores the extracted characteristic color as information to be used for the subsequent object tracking processing. In the case of the example illustrated in FIG. 6A, the system control circuit 206 extracts the color of a range 601 positioned at the center as the characteristic color of the object.

In step S404, the system control circuit 206 controls the initial arrangement of particles in the particle filter processing. The system control circuit 206 initially arranges all the particles at a central portion 602 as illustrated in FIG. 6A. It is desirable to arrange as many particles as possible considering the processing speed of the system control circuit 206. In the present exemplary embodiment, several hundreds of particles are arranged, although only ten representative particles are illustrated in the drawings. In FIG. 6A, all the particles are arranged to overlap one another at one position.

In step S405, similarly to step S401, the AE unit 108 performs an image-capturing operation and obtains light metering image data. FIG. 6B illustrates an example of the light metering image data obtained in this step. The example indicates that the object 600 has moved to the right.

In step S406, the system control circuit 206 performs object tracking processing based on the light metering image data obtained in step S405. More specifically, the system control circuit 206 estimates and tracks the position of the object 600 using the particle filter processing based on the characteristic color of the object 600 stored in step S403. The object tracking processing will be described in detail below with reference to FIG. 5.

In step S407, the system control circuit 206 determines whether the release button (not illustrated) has been pressed and the SW2 signal has been output. If the system control circuit 206 determines that the SW2 signal has not been output (NO in step S407), the operation returns to step S405. If the system control circuit 206 determines that the SW2 signal has been output (YES in step S407), the operation proceeds to step S408.

In step S408, the system control circuit 206 moves the main mirror 103 to the outside of the imaging optical path to cause the image sensor 111 to capture a still image. Then, the system control circuit 206 terminates the processing of the flowchart illustrated in FIG. 4.

FIG. 5 is a flowchart illustrating details of the object tracking processing (see step S406 in FIG. 4) according to the first exemplary embodiment. The system control circuit 206 repeatedly performs the object tracking processing illustrated in FIG. 5 during the SW1 holding state and continuous shooting.

In step S501, the system control circuit 206 randomly moves the particles according to a random number following the normal distribution. FIG. 6C illustrates an example in which each of the particles positioned in the central portion 602 is randomly moved. The dispersion of the normal distribution regarding the random movement of the particles will be described below in steps S508 and S509.

In step S502, the system control circuit 206 calculates likelihood at the position of each of the particles that have been randomly moved. The system control circuit 206 compares the color of the light metering image data at the position of each of the particles with the characteristic color of the object extracted in step S403 illustrated in FIG. 4, and calculates likelihood based on similarity between the compared colors. If the color at the position of the particle is similar to the characteristic color of the object, the system control circuit 206 determines that the likelihood is high. More specifically, the likelihood is an evaluation value indicating the level of correlation between the characteristic color of the object and the color at the position of the particle.

In step S503, the system control circuit 206 estimates the image region of the object based on the position of each particle having a higher likelihood. For example, in the example in FIG. 6D, the likelihood is high in an image region 603. Therefore, the system control circuit 206 estimates the image region 603 as the image region of the object.

In step S504, the system control circuit 206 adaptively arranges a particle having a lower likelihood in the position of a particle having a higher likelihood. This operation is referred to as so-called re-sampling processing in the particle filter processing. In the example illustrated in FIG. 6E, the system control circuit 206 adaptively arranges a particle having a lower likelihood (i.e., a particle not included in the image region 603 of the object) so as to be overlapped with a particle having a higher likelihood included in the image region 603.

In step S505, the system control circuit 206 performs, for the object of which the image region has been estimated in step S503, preparations for capturing a still image of the object, such as automatic exposure control (AE), auto-focus position control (AF), and automatic white balance control (AWB).

In step S506, the system control circuit 206 calculates a motion vector of the object based on a difference between the position of the object estimated in step S503 (i.e., post-movement position) and the position of the object in the previous stage (i.e., pre-movement position).

In step S507, the system control circuit 206 determines whether the movement amount of the motion vector calculated in step S506 is greater than a predetermined threshold value. If the system control circuit 206 determines that the movement amount is greater than the predetermined threshold value (YES in step S507), the operation proceeds to step S508. If the system control circuit 206 determines that the movement amount is not greater than the predetermined threshold value (NO in step S507), the operation proceeds to step S509.

In step S508, the system control circuit 206 changes the dispersion of the normal distribution to be greater for the random movement to be performed next in step S501. Then, the system control circuit 206 terminates the object tracking processing of the flowchart illustrated in FIG. 5. By changing the dispersion of the normal distribution in this manner, the particles can be arranged more effectively against a greatly moving object. As a result, the object is less likely to be lost in the object tracking operation because the particles are arranged against the object more effectively.

In step S509, the system control circuit 206 changes the dispersion of the normal distribution to be smaller for the random movement to be performed next in step S501. Then, the system control circuit 206 terminates the object tracking processing of the flowchart illustrated in FIG. 5. By changing the dispersion of the normal distribution in this manner, the particles can be arranged as many as possible against an object which does not move at all or does not move so much. As a result, the reliability in determining whether the tracking target is the target object can be further enhanced because many of the particles are arranged against the object.

The above-described operation allows the particles to be continuously arranged in the position of the object, by widening the distribution of the particles in the particle filter processing in a case where the movement amount of the object is large. As a result, the object can be continuously tracked in an appropriate manner.

In the present exemplary embodiment, the imaging apparatus changes the operation by determining whether the motion vector is greater than the predetermined threshold value as described in step S507. However, as another example, the operation may be changed at multiple stages according to the size of the calculated motion vector. By performing such an operation, the distribution of the particles can be changed more appropriately in response to a change of the object position.

In the first exemplary embodiment, the imaging apparatus changes the way of distributing the particles in the particle filter processing according to the movement amount of the object to be tracked.

In a second exemplary embodiment, instead of the movement amount of the object, a moving speed of the object that is obtained based on the movement amount per unit time is used. An imaging apparatus according to the second exemplary embodiment is similar in configuration and shooting operation to that described in the first exemplary embodiment. The second exemplary embodiment is different from the first exemplary embodiment in the operation of the object tracking processing, which will be mainly described below.

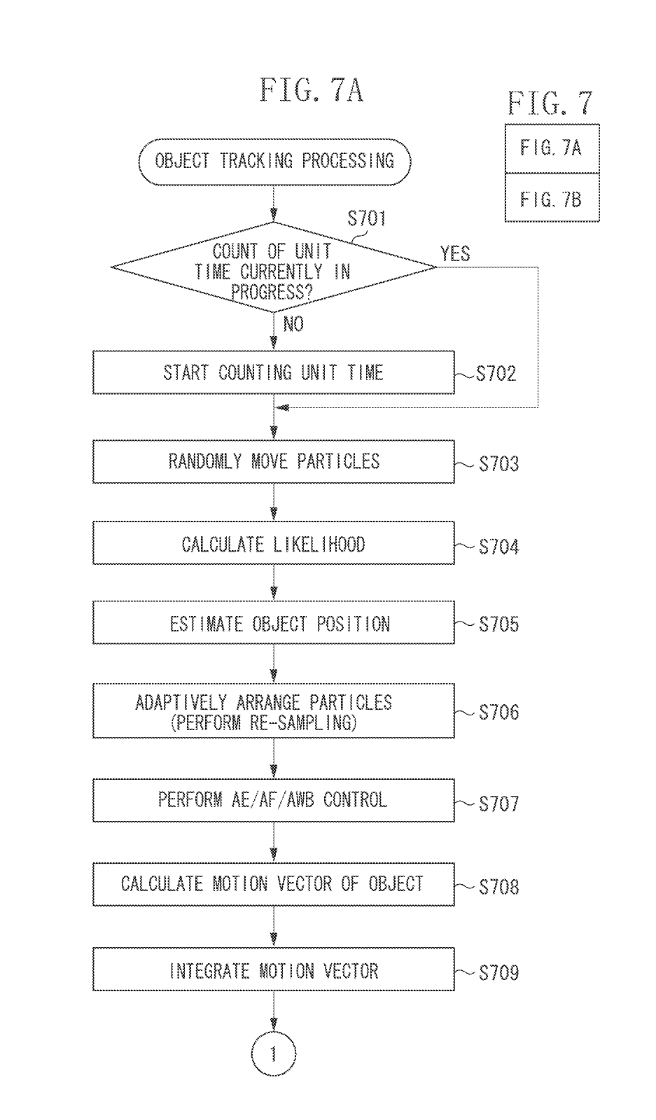

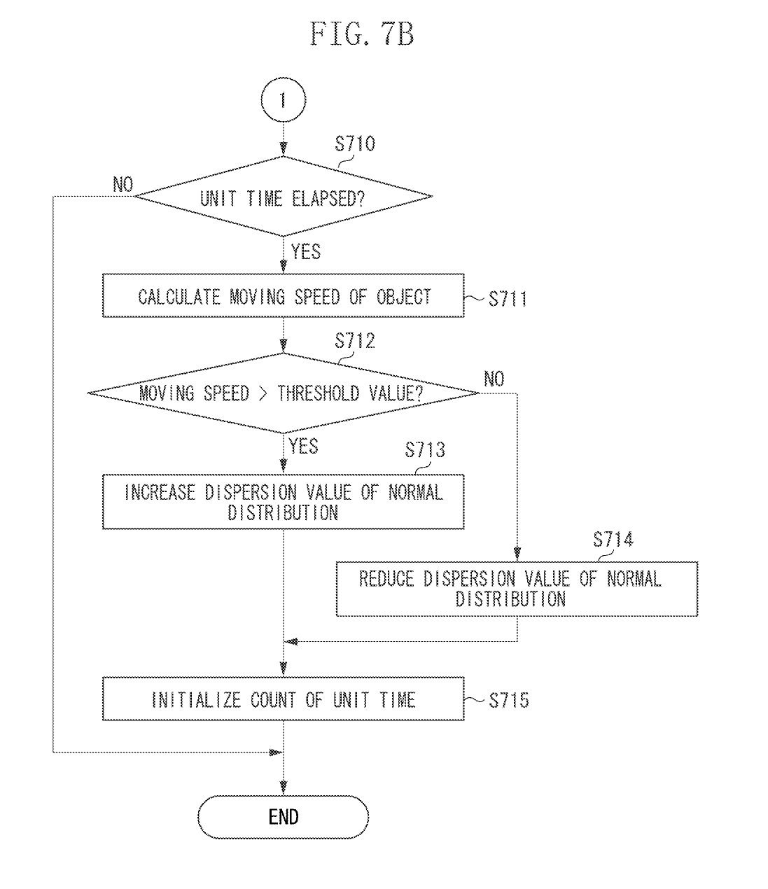

FIG. 7 is a flowchart illustrating details of the object tracking processing (see step S406 illustrated in FIG. 4) according to the second exemplary embodiment. The system control circuit 206 repeatedly performs the object tracking processing illustrated in FIG. 7 during the SW1 holding state and continuous shooting.

In step S701, the system control circuit 206 determines whether count of a unit time is currently in progress. In this case, the unit time is a reference time to be used to calculate the moving speed of the object. For example, the unit time may be 0.5 sec. or 1 sec. (i.e., a time being directly expressed) or may be the latest three still images in continuous still image shooting (i.e., a time being indirectly expressed based on a predetermined number of continuously captured images). Further, any other appropriate criterion may be employed to express the unit time. If the system control circuit 206 determines that the count of the unit time is currently in progress (YES in step S701), the operation proceeds to step S703. If the system control circuit 206 determines that the count of the unit time is not yet performed (NO in step S701), then in step S702, the system control circuit 206 starts counting the unit time. Subsequently, the operation proceeds to step S703.

In step S703, the system control circuit 206 randomly moves the particles according to the random number following the normal distribution (see FIG. 6C).

In step S704, the system control circuit 206 calculates likelihood at the position of each of the particles that have been randomly moved. The system control circuit 206 compares the color of the light metering image data at the position of each of the particles with the characteristic color of the object extracted in step S403 illustrated in FIG. 4, and calculates likelihood based on similarity between the compared colors. If the color at the position of the particle is similar to the characteristic color of the object, the system control circuit 206 determines that the likelihood is high.

In step S705, the system control circuit 206 estimates the image region of the object based on the position of each particle having a higher likelihood (see FIG. 6D).

In step S706, the system control circuit 206 adaptively arranges a particle having a lower likelihood in the position of a particle having a higher likelihood (i.e., performs re-sampling processing, see FIG. 6E).

In step S707, the system control circuit 206 performs, for the object of which the image region has been estimated in step S705, preparations for capturing a still image of the object, such as automatic exposure control (AE), auto-focus position control (AF), and automatic white balance control (AWB).

In step S708, the system control circuit 206 calculates the motion vector of the object based on a difference between the position of the object estimated in step S705 (i.e., post-movement position) and the position of the object in the previous stage (i.e., pre-movement position).

In step S709, the system control circuit 206 integrates the motion vectors calculated in step S708. The integrated result is later converted into a moving speed in an operation step to be described below.

In step S710, the system control circuit 206 determines whether the unit time (i.e., the reference time in calculating the moving speed of the object) has elapsed. If the system control circuit 206 determines that the unit time has elapsed (YES in step S710), the operation proceeds to step S711. If the system control circuit 206 determines that the unit time has not elapsed (NO in step S710), the system control circuit 206 terminates the object tracking processing of the flowchart illustrated in FIG. 7. In this case, as illustrated in steps S406 and S407 of FIG. 4, as long as the SW1 signal is continuously output, the system control circuit 206 repeatedly calls the object tracking processing. With such an operation, the movement amounts of the object can be continuously integrated until the unit time elapses.

In step S711, the system control circuit 206 calculates the moving speed of the object from the integrated motion vector value per unit time, based on the integrated motion vector value calculated in step S709.

In step S712, the system control circuit 206 determines whether the moving speed calculated in step S711 is greater than a predetermined threshold value. If the system control circuit 206 determines that the moving speed is greater than the predetermined threshold value (YES in step S712), the operation proceeds to step S713. If the system control circuit 206 determines that the moving speed is not greater than the predetermined threshold value (NO in step S712), the operation proceeds to step S714.

In step S713, the system control circuit 206 changes the dispersion of the normal distribution to be greater for the random movement to be performed next in step S703. By changing the dispersion of the normal distribution in this manner, the particles can be arranged more effectively against an object which moves at a high speed. As a result, the object is less likely to be lost in the object tracking processing because the particles are arranged against the object more effectively.

In step S714, the system control circuit 206 changes the dispersion of the normal distribution to be smaller for the random movement to be performed next in step S703. By changing the dispersion of the normal distribution in this manner, the particles can be arranged as many as possible against an object which does not move at all or moves at a low speed. As a result, the reliability of the tracking processing can be further enhanced because many of the particles are arranged against the object.

In step S715, the system control circuit 206 initializes the count of the unit time for the next time count operation (namely, for measuring the next unit time) in response to the change of the dispersion of the normal distribution. Then, the system control circuit 206 terminates the object tracking processing of the flowchart illustrated in FIG. 7. The above-described operation allows the particles to be continuously arranged in the position of the object, by widening the distribution of the particles in the particle filter processing in a case where the moving speed of the object is high. As a result, the object can be continuously tracked in an appropriate manner.

In the present exemplary embodiment, the imaging apparatus calculates the moving speed based on the count of the unit time (i.e., the reference time to be used to calculate the moving speed of the object) and then initializes the count of the unit time. However, as another example, the imaging apparatus may store each of the motion vectors to be integrated in step S709 and perform an operation to integrate each of the stored motion vectors retroactively to the amount corresponding to the unit time each time the imaging apparatus performs the processing in step S709. By performing such an operation, the timing of changing the dispersion of the normal distribution relating to the random movement to be performed in step S703 can be finely set. As a result, the particles can be arranged in the position of the object appropriately in response to a change of the moving speed of the object.

Further, in the present exemplary embodiment, the imaging apparatus changes the operation by determining whether the moving speed is greater than the predetermined threshold value as described in step S712. However, as another example, the operation may be changed at multiple stages according to the calculated moving speed. By performing such an operation, the distribution of the particles can be changed more appropriately in response to a change of the object position.

In the first and second exemplary embodiments, the imaging apparatus changes the way of distributing the particles in the particle filter processing according to the movement amount or the moving speed of the object to be tracked.

In a third exemplary embodiment, the way of distributing the particles is changed according to the size of the object to be tracked so as to constantly arrange the particles in the position of the object at a predetermined rate, so that the object can be tracked more stably. An imaging apparatus according to the third exemplary embodiment is similar in both configuration and shooting operation to that described in the first exemplary embodiment. The third exemplary embodiment is different from the first exemplary embodiment in the operation of the object tracking processing, which will be mainly described below.

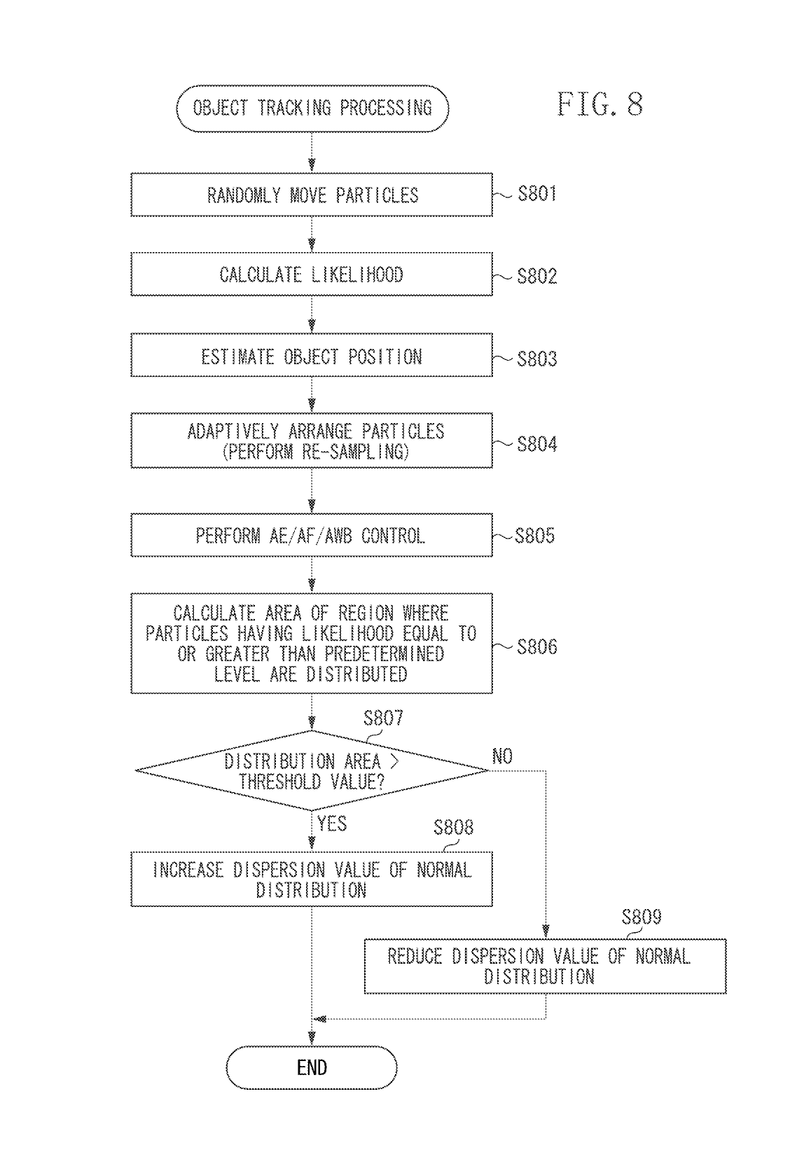

FIG. 8 is a flowchart illustrating details of the object tracking processing (see step S406 illustrated in FIG. 4) according to the third exemplary embodiment.

In step S801, the system control circuit 206 randomly moves the particles according to the random number following the normal distribution (see FIG. 6C).

In step S802, the system control circuit 206 calculates likelihood at the position of each of the particles that have randomly been moved. The system control circuit 206 compares the color of the light metering image data at the position of each of the particles with the characteristic color of the object extracted in step S403 illustrated in FIG. 4, and calculates likelihood based on similarity between the compared colors. If the color at the position of the particle is similar to the characteristic color of the object, the system control circuit 206 determines that the likelihood is high.

In step S803, the system control circuit 206 estimates the image region of the object based on the position of each particle having a higher likelihood (see FIG. 6D)

In step S804, the system control circuit 206 adaptively arranges a particle having a lower likelihood in the position of a particle having a higher likelihood (i.e., performs re-sampling processing, see FIG. 6E).

In step S805, the system control circuit 206 performs, for the object of which the image region has been estimated in step S803, preparations for capturing a still image of the object, such as automatic exposure control (AE), auto-focus position control (AF), and automatic white balance control (AWB).

In step S806, the system control circuit 206 calculates the area of the object in the light metering image data based on the image region of the object estimated in step S803. The image region of the object is estimated, through the processing in steps S802 and S803, based on similarity between the color of the light metering image data at the position of each of the particles and the characteristic color of the object extracted in step S403 in FIG. 4. Accordingly, by calculating the area of the region where particles having likelihood equal to or greater than a predetermined level are distributed, a color region that has higher similarity to the characteristic color of the object is recognized as the image region of the object, so that the area of the object is calculated.

In step S807, the system control circuit 206 determines whether the area calculated in step S806 is greater than a predetermined threshold value. If the system control circuit 206 determines that the area is greater than the predetermined threshold value (YES in step S807), the operation proceeds to step S808. If the system control circuit 206 determines that the area is not greater than the predetermined threshold value (NO in step S807), the operation proceeds to step S809.

In step S808, the system control circuit 206 changes the dispersion of the normal distribution to be greater for the random movement to be performed next in step S801. The system control circuit 206 terminates the object tracking processing of the flowchart illustrated in FIG. 8. Because the operation is performed under a condition that the area of the object is relatively large with respect to the light metering image data, the arrangement of the particles is expanded so that various portions of the object can be tracked more easily in the particle filter processing. As a result, the object can be tracked more stably.

In step S809, the system control circuit 206 changes the dispersion of the normal distribution to be smaller for the random movement to be performed next in step S801. Then, the system control circuit 206 terminates the object tracking processing of the flowchart illustrated in FIG. 8. Because the operation is performed under a condition that the area of the object is relatively small with respect to the light metering image data, the arrangement of the particles is narrowed, so that the reliability in determining whether the tracking target is the target object can be further enhanced in the particle filter processing.

By performing the above-described operation, the distribution of the particles can be changed according to the number of particles having a high likelihood. This makes it easier to constantly arrange the particles in the position of the object at a predetermined rate, thereby allowing the tracking of the object more stably.

### Modification Example

In the present exemplary embodiment, the imaging apparatus performs a tracking operation based on the characteristic color of the target object image, and calculates the area of the object in the light metering image data based on the similarity of compared colors (see step S806). However, as another example, the area of the object may be calculated based on similarity in luminance or color saturation or based on overall similarity considering these features. By calculating the area of the object based on various similarity results, the area of the object can be calculated more accurately.

Further, in the present exemplary embodiment, the imaging apparatus changes the operation by determining whether the area of the object is greater than the predetermined threshold value as described in step S807. However, as another example, the operation may be changed at multiple stages according to the calculated area. By performing such an operation, the distribution of the particles can be changed more appropriately in response to a change of the object position.

In a fourth exemplary embodiment, the way of distributing the particles in the particle filter processing is changed according to the state (or various settings) of the imaging apparatus.

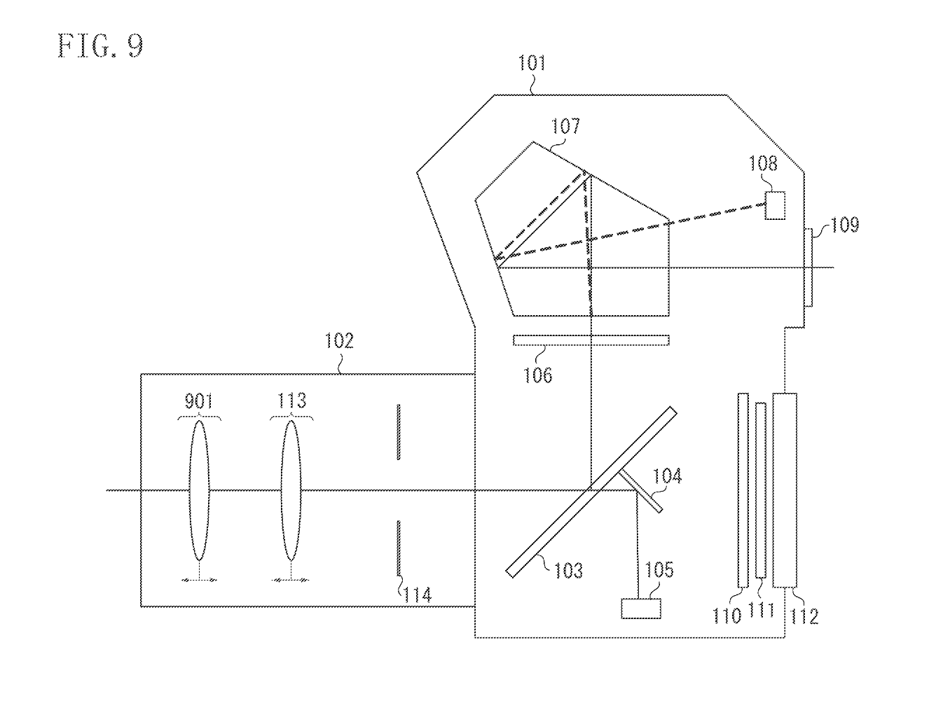

FIG. 9 is a cross-sectional view illustrating a digital single-lens reflex camera as an example of the imaging apparatus according to the fourth exemplary embodiment. The configuration illustrated in FIG. 9 is different from that illustrated in FIG. 1 in that a zoom lens 901 is additionally provided to change the focal length of the interchangeable lens 102. Constituent components similar to those illustrated in FIG. 1 are denoted by the same reference numerals and redundant description thereof will be avoided. Further, the imaging apparatus according to the fourth exemplary embodiment performs shooting operations that are similar to those described in the first exemplary embodiment. The fourth exemplary embodiment is different from the first exemplary embodiment in the operation of the object tracking processing, which will be mainly described below.

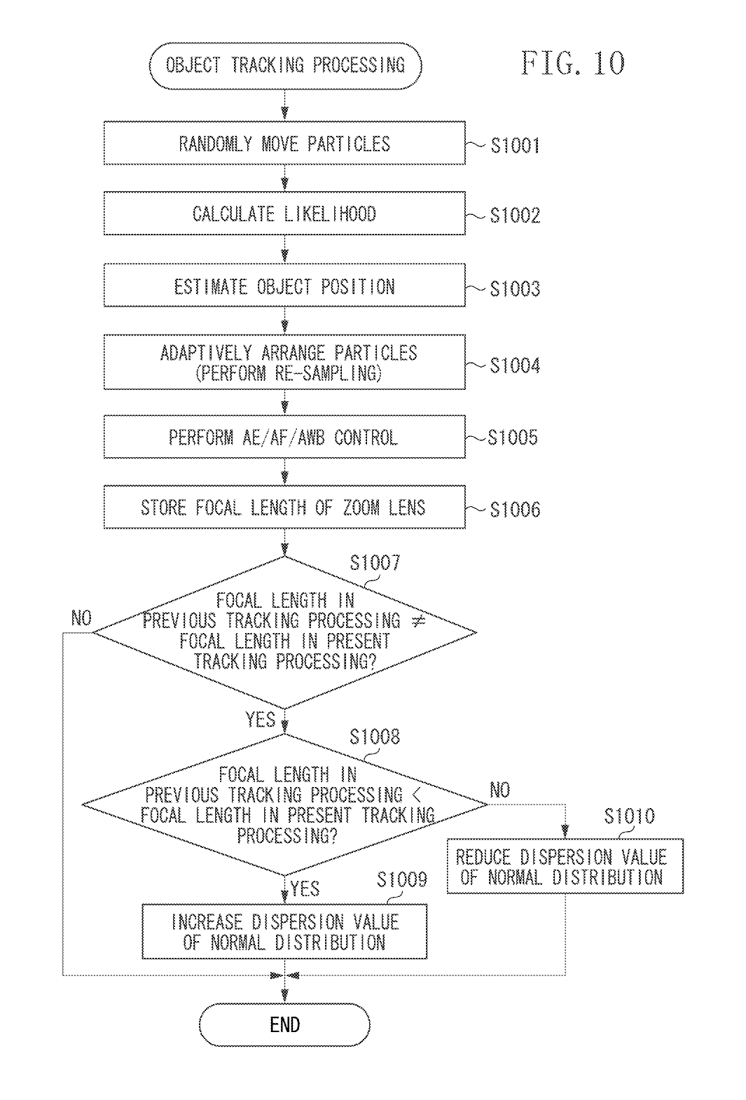

FIG. 10 is a flowchart illustrating details of the object tracking processing (see step S406 in FIG. 4) according to the fourth exemplary embodiment.

In step S1001, the system control circuit 206 randomly moves the particles according to the random number following the normal distribution (see FIG. 6C).

In step S1002, the system control circuit 206 calculates likelihood at the position of each of the particles that have randomly been moved. The system control circuit 206 compares the color of the light metering image data at the position of each of the particles with the characteristic color of the object extracted in step S403 illustrated in FIG. 4, and calculates likelihood based on similarity between the compared colors. If the color of the position of the particle is similar to the characteristic color of the object, the system control circuit 206 determines that the likelihood is high.

In step S1003, the system control circuit 206 estimates the image region of the object based on the position of each particle having a higher likelihood (see FIG. 6D).

In step S1004, the system control circuit 206 adaptively arranges a particle having a lower likelihood in the position of a particle having a higher likelihood (i.e., performs re-sampling processing, see FIG. 6E).

In step S1005, the system control circuit 206 performs, for the object of which the image region has been estimated in step S1003, preparations for capturing a still image of the object, such as automatic exposure control (AE), auto-focus position control (AF), and automatic white balance control (AWB).

In step S1006, the system control circuit 206 stores the focal length of the zoom lens 901.

In step S1007, the system control circuit 206 compares the focal length stored in step S1006 in the previous object tracking processing with the focal length stored in the latest step S1006 in the present object tracking processing. If the system control circuit 206 determines that the compared focal lengths are different from each other (YES in step S1007), the operation proceeds to step S1008. If the system control circuit 206 determines that the compared focal lengths are identical to each other, namely, if the focal length of the zoom lens 901 is not changed (NO in step S1007), the system control circuit 206 terminates the object tracking processing of the flowchart illustrated in FIG. 10, because it is not necessary to change the distribution of particles.

In step S1008, the system control circuit 206 compares the previous focal length with the present focal length. If the present focal length is longer than the previous focal length (YES in step S1008), the system control circuit 206 determines that it is necessary to increase the dispersion of the particles because of the possibility that the captured object image is larger than the previous one and the present particle dispersion may cause the particles to be arranged only in a part of the object image. Thus, the operation proceeds to step S1009. If the previous focal length is longer than the present focal length (NO in step S1008), the system control circuit 206 determines that it is necessary to reduce the dispersion of the particles because of the possibility that the captured object image is smaller than the previous one and the present particle dispersion may cause many of the particles to be arranged in a region other than the object image. Thus, the operation proceeds to step S1010.

In step S1009, the system control circuit 206 changes the dispersion of the normal distribution to be greater for the random movement to be performed next in step S1001. Then, the system control circuit 206 terminates the object tracking processing of the flowchart illustrated in FIG. 10. By changing the dispersion of the normal distribution in this manner, many of the particles can be arranged in various portions of the object even when the captured object image is larger than the previous one. As a result, the object is less likely to be lost in the object tracking operation.

In step S1010, the system control circuit 206 changes the dispersion of the normal distribution to be smaller for the random movement to be performed next in step S1001. Then, the system control circuit 206 terminates the object tracking processing of the flowchart illustrated in FIG. 10. Changing the dispersion of the normal distribution in this manner makes it easier to arrange many of the particles against the object even when the captured object image is smaller than the previous one.

By performing the above-described operation, the particles can be continuously arranged in the position of the object as uniformly as possible, in response to a change in the focal length of the zoom lens 901. As a result, the object can be continuously tracked in an appropriate manner.

### Modification Example

In the present exemplary embodiment, the imaging apparatus changes the distribution of the particles in the particle filter processing in response to a change in the focal length of the zoom lens 901. However, as another example, the imaging apparatus may monitor a focus detection result of an AF distance measurement frame overlapping with the position of the object in the AF unit 105 to change the distribution of the particles in response to a change of the focus detection result. If the focus detection result indicates that the object comes closer to the imaging apparatus, the imaging apparatus may perform control to increase the dispersion of the particles because of the possibility that the captured object image is larger than that in the previous object tracking operation and the present particle dispersion may cause the particles to be arranged only in a part of the object image. On the other hand, if the focus detection result indicates that the object moves away from the imaging apparatus, the imaging apparatus may perform control to reduce the dispersion of the particles because of the possibility that the captured object image is smaller than that in the previous object tracking operation and the present particle dispersion may cause many of the particles to be arranged in a region other than the object image. By performing such control, the particles can be continuously arranged in the position of the object more promptly and as uniformly as possible, based on the change in the focus detection result.

Further, other than the present exemplary embodiment, the focus lens 113 may be configured to possess distance information based on an optical design of the interchangeable lens 102 so that a combination of focal length/focal position information can be used to estimate the object distance. In this case, the imaging apparatus can change the distribution of the particles according to the object distance estimated based on the focal length and the focus detection result. If the distance to the object is short, the imaging apparatus can perform control to make the dispersion of the particles relatively large according to the short distance because the size of the captured object image is large. Further, if the distance to the object is long, the imaging apparatus can perform control to make the dispersion of the particles relatively small according to the long distance because the size of the captured object image is small. With the above-described configuration and control, the particles can be continuously arranged in the position of the object more promptly and as uniformly as possible based on the change in the focus detection result, similarly to the above-described modification example.

Further, in the present exemplary embodiment, the imaging apparatus changes the operation based on the comparison between the previous focal length and the present focal length as described in step S1007. However, as another example, the operation may be changed at multiple stages according to the level of the difference between the previous focal length and the present focal length. By performing such an operation, the distribution of the particles can be changed more appropriately in response to a change of the object image.

In a fifth exemplary embodiment, the way of distributing the particles is changed according to a camera posture operation (e.g., pan or tilt) or the degree of camera shake.

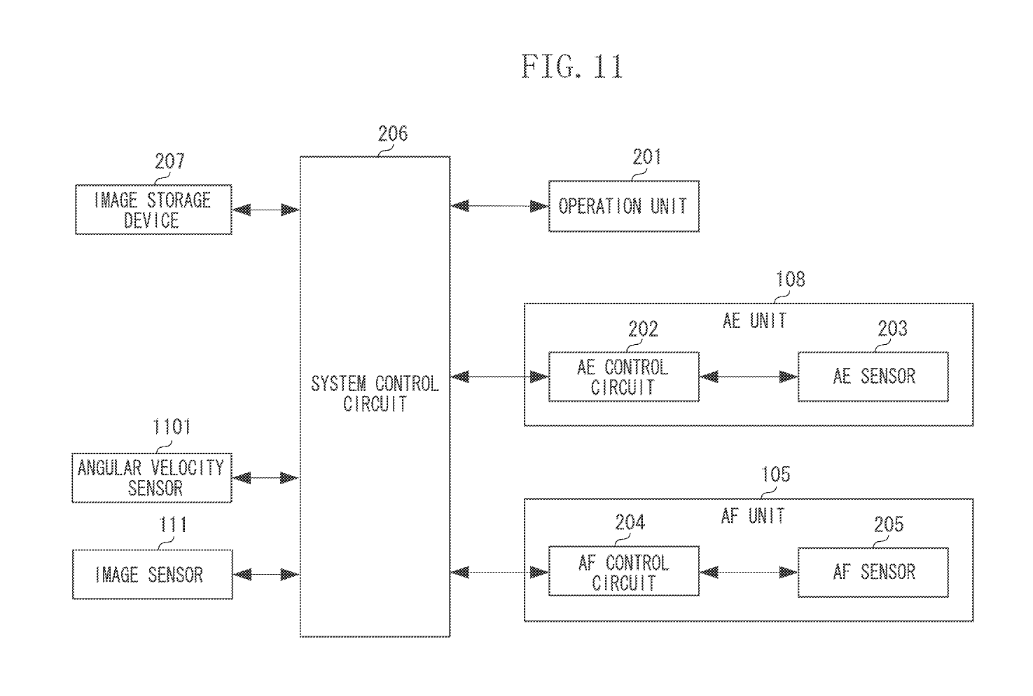

FIG. 11 illustrates a configuration of an imaging apparatus according to the fifth exemplary embodiment. The imaging apparatus illustrated in FIG. 11 is different from the apparatus illustrated in FIG. 2 in that an angular velocity sensor 1101 capable of detecting an angular velocity occurring in each of roll/yaw/pitch directions of the imaging apparatus is additionally provided. Constituent components similar to those illustrated in FIGS. 1 and 2 are denoted by the same reference numerals and redundant description thereof will be avoided. Further, the imaging apparatus according to the fifth exemplary embodiment performs shooting operations that are similar to those described in the first exemplary embodiment. The fifth exemplary embodiment is different from the first exemplary embodiment in the operation of the object tracking processing, which will be mainly described below.

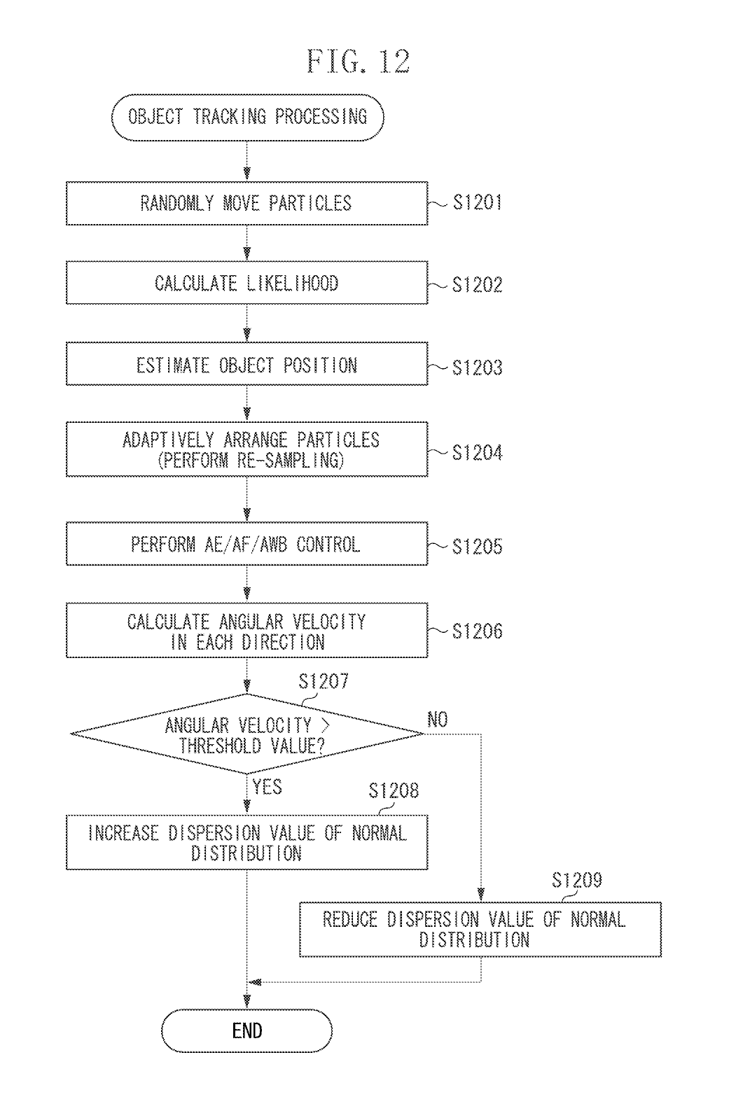

FIG. 12 is a flowchart illustrating details of the object tracking processing (see step S406 illustrated in FIG. 4) according to the fifth exemplary embodiment.

In step S1201, the system control circuit 206 randomly moves the particles according to the random number following the normal distribution (see FIG. 6C).

In step S1202, the system control circuit 206 calculates likelihood at the position of each of the particles that have randomly been moved. The system control circuit 206 compares the color of light metering image data at the position of each of the particles with the characteristic color of the object extracted in step S403 illustrated in FIG. 4, and calculates likelihood based on similarity between the compared colors. If the color at the position of the particle is similar to the characteristic color of the object, the system control circuit 206 determines that the likelihood is high.

In step S1203, the system control circuit 206 estimates the image region of the object based on the position of each particle having a higher likelihood (see FIG. 6D).

In step S1204, the system control circuit 206 adaptively arranges a particle having a lower likelihood in the position of a particle having a higher likelihood (i.e., performs re-sampling processing, see FIG. 6E).

In step S1205, the system control circuit 206 performs, for the object of which the image region has been estimated in step S1203, preparations for capturing a still image of the object, such as automatic exposure control (AE), auto-focus position control (AF), and automatic white balance control (AWB).

In step S1206, the system control circuit 206 causes the angular velocity sensor 1101 to detect an angular velocity in each of the roll/yaw/pitch directions of the imaging apparatus.

In step S1207, the system control circuit 206 determines whether the angular velocity in any one of the above-described directions is greater than a predetermined threshold value. If the angular velocity in any one of the above-described directions is greater than the predetermined threshold value (YES in step S1207), the system control circuit 206 determines that the particles may not be able to be arranged in the position of the object if the present particle distribution in the particle filter processing is used, because the position of the object image has been moved in the light metering image data due to the camera posture operation or the camera shake. Therefore, in this case, the operation proceeds to step S1208. If the system control circuit 206 determines that the angular velocity in each of the above-mentioned directions is not greater than the predetermined threshold value (NO in step S1207), the operation proceeds to step S1209.

In step S1208, the system control circuit 206 changes the dispersion of the normal distribution to be greater for the random movement to be performed next in step S1201. Then, the system control circuit 206 terminates the object tracking processing of the flowchart illustrated in FIG. 12. By changing the dispersion of the normal distribution in this manner, the object can be tracked more stably even when the camera posture operation is performed or when the camera shake occurs.

In step S1209, the system control circuit 206 changes the dispersion of the normal distribution to be smaller for the random movement to be performed next in step S1201. Then, the system control circuit 206 terminates the object tracking processing of the flowchart illustrated in FIG. 12. By changing the dispersion of the normal distribution in this manner, the particles can be arranged as many as possible against an object which does not move at all or does not move so much. As a result, the reliability in determining whether the tracking target is the target object can be further enhanced because many of the particles are arranged against the object.

By performing the above-described operation, the object can be tracked more stably because the way of distributing the particles in the particle filter processing is changed according to the camera posture operation (e.g., pan/tilt) or the degree of the camera shake.

In the present exemplary embodiment, if the angular velocity sensor 1101 does not detect any angular velocity that exceeds the predetermined threshold value in the above-described directions, the imaging apparatus reduces the dispersion of the normal distribution as described in step S1209. However, as another example, the configuration may be such that the imaging apparatus does not change the dispersion of the normal distribution in the above-described case.

Further, in the present exemplary embodiment, the angular velocity sensor 1101 is configured to detect the angular velocity in each of the roll/yaw/pitch directions of the imaging apparatus. However, as another example, the angular velocity sensor 1101 may be replaced by an acceleration sensor installed in at least one direction of the camera posture to detect acceleration so that the camera posture operation or the camera shake is detected.

Further, in the present exemplary embodiment, the imaging apparatus changes the operation by determining whether the angular velocity detected in any one of the above-described directions exceeds the predetermined threshold value as described in step S1207. However, as another example, the operation may be changed at multiple stages according to the magnitude of the detected angular velocity. By performing such an operation, the distribution of the particles can be changed more appropriately in response to a change of the object image.

In the object tracking using the particle filter processing, the imaging apparatus extracts a feature of an object at the position of each of the particles, and calculates likelihood between the extracted feature and the target object. However, in a case where the luminance of an object is low or an imaging ISO sensitivity is high, the S/N ratio deteriorates due to pixel noises and the likelihood at the position of each of the particles tends to decrease compared to the case where the S/N ratio is adequate.

According to a sixth exemplary embodiment, the object tracking processing can be performed more stably in a condition where the S/N ratio of the light metering image data is worsened. An imaging apparatus according to the sixth exemplary embodiment is similar in both configuration and shooting operation to that described in the first exemplary embodiment. The sixth exemplary embodiment is different from the first exemplary embodiment in the operation of the object tracking processing, which will be mainly described below.

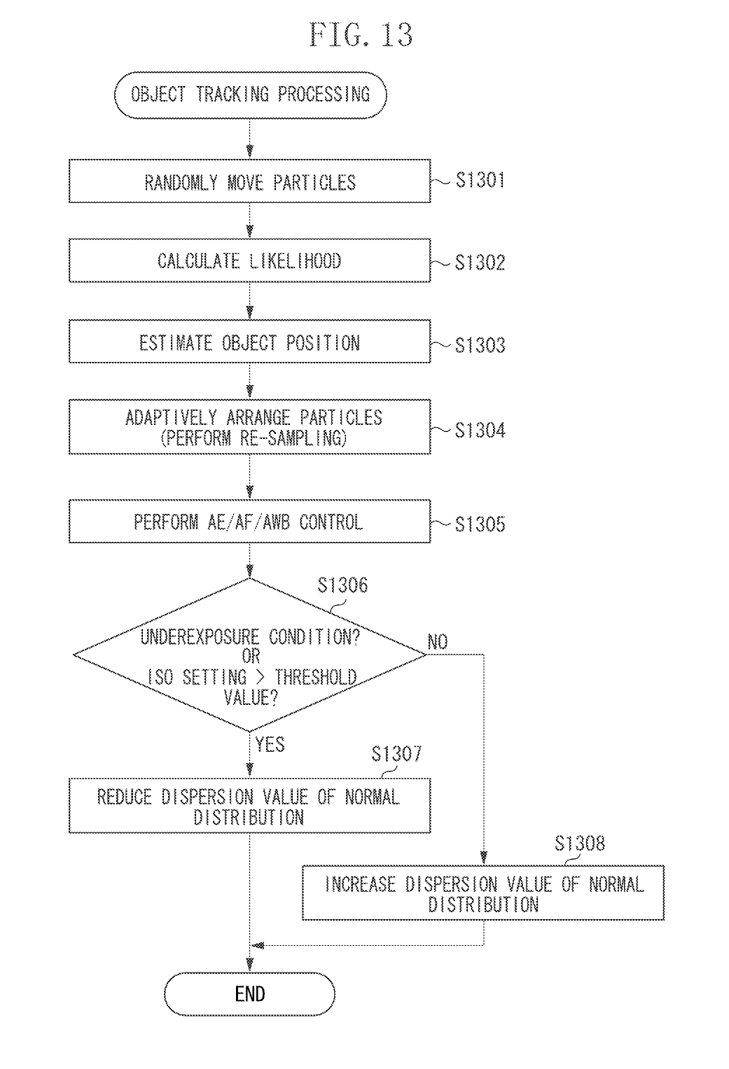

FIG. 13 is a flowchart illustrating details of the object tracking processing (see step S406 illustrated in FIG. 4) according to the sixth exemplary embodiment.

In step S1301, the system control circuit 206 randomly moves the particles according to the random number following the normal distribution (see FIG. 6C).

In step S1302, the system control circuit 206 calculates likelihood at the position of each of the particles that have randomly been moved. The system control circuit 206 compares the color of the light metering image data at the position of each of the particles with the characteristic color of the object extracted in step S403 illustrated in FIG. 4, and calculates likelihood based on similarity between the compared colors. If the color at the position of the particle is similar to the characteristic color of the object, the system control circuit 206 determines that the likelihood is high.

In step S1303, the system control circuit 206 estimates the image region of the object based on the position of each particle having a higher likelihood (see FIG. 6D).

In step S1304, the system control circuit 206 adaptively arranges a particle having a lower likelihood in the position of a particle having a higher likelihood (i.e., performs re-sampling processing, see FIG. 6E).

In step S1305, the system control circuit 206 performs, for the object of which the image region has been estimated in step S1303, preparations for capturing a still image of the object, such as automatic exposure control (AE), auto-focus position control (AF), and automatic white balance control (AWB).

In step S1306, the system control circuit 206 determines whether the exposure condition is underexposure or an ISO sensitivity setting value is greater than a predetermined threshold value (e.g., ISO1600) with reference to the exposure condition set to obtain the light metering image data in step S405 illustrated in FIG. 4. If the system control circuit 206 determines that the exposure condition is underexposure or the ISO sensitivity setting value is greater than the predetermined threshold value (YES in step S1306), the operation proceeds to step S1307 to perform particle filter processing for pixel noise prevention. If the system control circuit 206 determines that the exposure condition is not underexposure or the ISO sensitivity setting value is equal to or less than the predetermined threshold value (NO in step S1306), the operation proceeds to step S1308.

In step S1307, the system control circuit 206 changes the dispersion of the normal distribution to be smaller for the random movement to be performed next in step S1301. Then, the system control circuit 206 terminates the object tracking processing of the flowchart illustrated in FIG. 13. By changing the dispersion of the normal distribution in this manner, the particles can be arranged as many as possible against the object. As a result, the reliability of the tracking processing can be enhanced in a condition where pixel noises frequently occur, because many of the particles can be arranged in the position of the object.

In step S1308, the system control circuit 206 changes the dispersion of the normal distribution to be greater for the random movement to be performed next in step S1301. Then, the system control circuit 206 terminates the object tracking processing of the flowchart illustrated in FIG. 13. Changing the dispersion of the normal distribution in this manner makes it easier to arrange the particles in the position of the object even in a situation where the detection accuracy of the object position is lowered due to the adverse effects of pixel noises.

By performing the above-described operation, the distribution of the particles of the particle filter can be changed according to the exposure condition even in the environment where the S/N ratio of the light metering image data is worsened. As a result, the object can be tracked more stably.

In the present exemplary embodiment, the imaging apparatus changes the dispersion of the normal distribution to be greater if, with respect to the exposure condition set to obtain the light metering image data, the exposure condition is not underexposure or the ISO sensitivity setting value is equal to or greater than the predetermined threshold value, as described in step S1308. However, as another example, the configuration may be such that the imaging apparatus does not change the dispersion of the normal distribution in the above-described case.

Further, in the present exemplary embodiment, the imaging apparatus changes the dispersion of the normal distribution to be smaller if, with respect to the exposure condition set to obtain the light metering image data, the exposure condition is underexposure or the ISO sensitivity setting value is greater than the predetermined threshold value, as described in step S1307. However, as another example, the imaging apparatus may perform a smoothing operation with a low-frequency filter to obtain light metering image data to be used in the object tracking processing so that the imaging apparatus can perform the particle filter processing while adequately suppressing adverse effects of pixel noises. In this case, it becomes difficult to extract a detailed state of the object. However, for example, in a case where a transmission band to be set is approximately one-third of the Nyquist frequency, the above-described smoothing operation does not have a large influence on the particle filter processing to be performed based on the characteristic color. By performing such an operation, the object can be tracked more stably in the situation where the S/N ratio of the light metering image data deteriorates, similarly to the effects of the present exemplary embodiment.

Further, in the present exemplary embodiment, the imaging apparatus changes the operation by determining whether the exposure condition is underexposure or the ISO sensitivity setting value is greater than the predetermined threshold value, as described in step S1306. However, as another example, the operation may be changed at multiple stages according to the degree of underexposure or the ISO sensitivity setting value. By performing such an operation, the distribution of the particles can be changed more appropriately in response to a change of the object image.

According to a seventh exemplary embodiment, the object tracking processing can be appropriately performed according to vertical and horizontal positions of the camera.

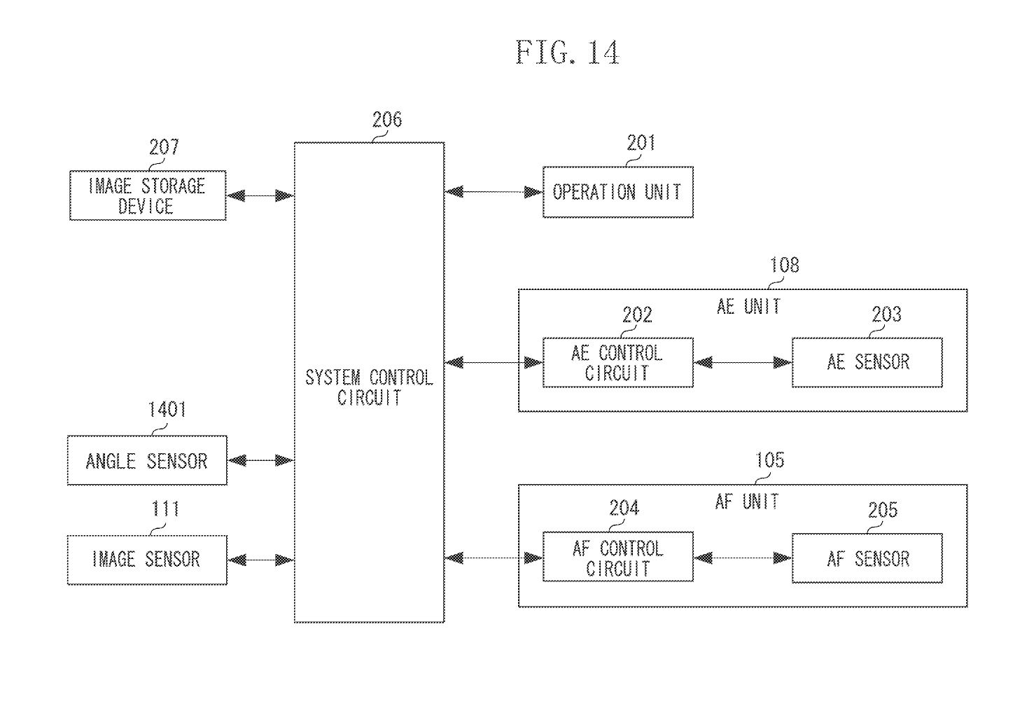

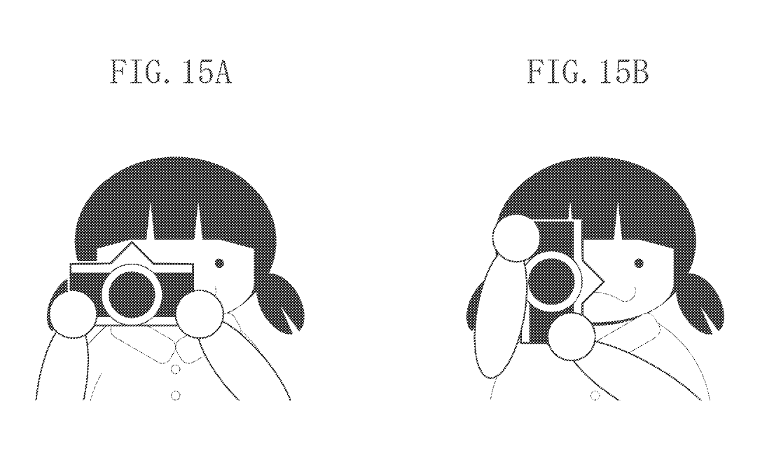

FIG. 14 illustrates a configuration of an imaging apparatus according to the seventh exemplary embodiment. The imaging apparatus illustrated in FIG. 14 is different from the apparatus illustrated in FIG. 2 in that an angle sensor 1401 capable of detecting an angle of the camera relative to the ground surface is additionally provided. The angle sensor 1401 can detect the horizontal position of the camera illustrated in FIG. 15A or the vertical position of the camera illustrated in FIG. 15B. Constituent components similar to those illustrated in FIGS. 1 and 2 are denoted by the same reference numerals and redundant description thereof will be avoided. Further, the imaging apparatus according to the seventh exemplary embodiment performs shooting operations that are similar to those described in the first exemplary embodiment. The seventh exemplary embodiment is different from the first exemplary embodiment in the operation of the object tracking processing, which will be mainly described below.

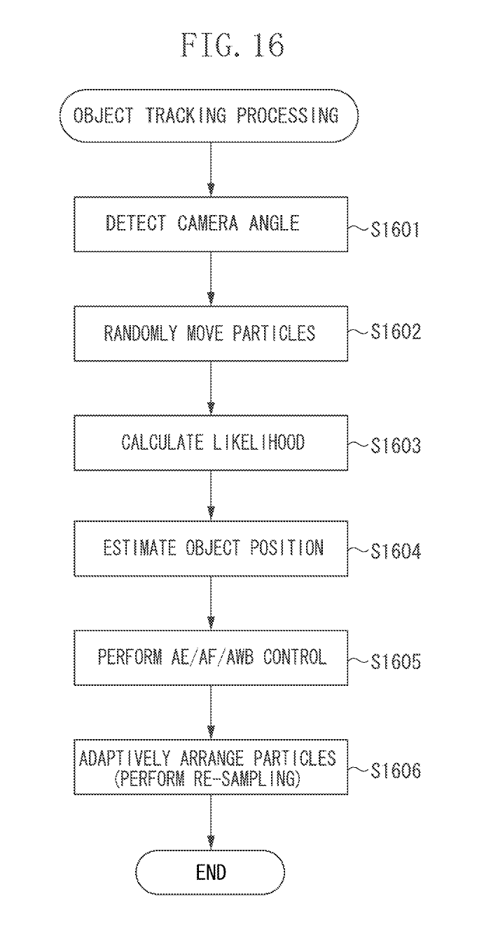

FIG. 16 is a flowchart illustrating details of the object tracking processing (see step S406 illustrated in FIG. 4) according to the seventh exemplary embodiment.

In step S1601, the system control circuit 206 obtains an angle value detected by the angle sensor 1401. In the present exemplary embodiment, the angle sensor 1401 detects an angle at intervals of 90 degrees to detect the horizontal position as illustrated in FIG. 15A or the vertical position as illustrated in FIG. 15B. However, the angular interval is not limited to 90 degrees and any smaller angle is employable.

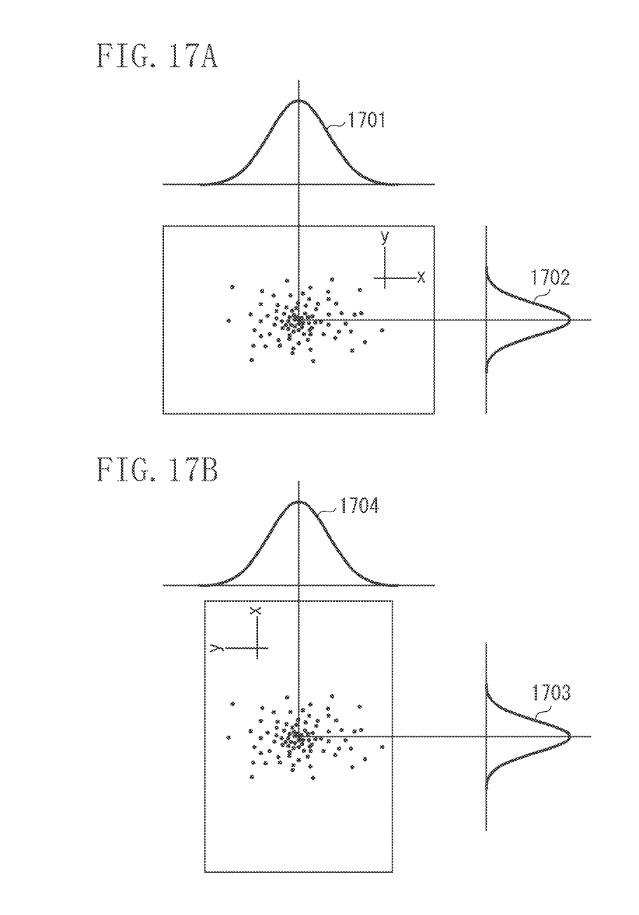

In step S1602, the system control circuit 206 randomly moves the particles according to the random number following the normal distribution (see FIG. 6C). In this case, the system control circuit 206 changes the dispersion of the normal distribution according to the angle detected in step S1601, which will be described in detail below with reference to FIGS. 17A and 17B.

In step S1603, the system control circuit 206 calculates likelihood at the position of each of the particles that have randomly been moved. The system control circuit 206 compares the color of the light metering image data at the position of each of the particles with the characteristic color of the object extracted in step S403 illustrated in FIG. 4, and calculates likelihood based on similarity between the compared colors. If the color at the position of the particle is similar to the characteristic color of the object, the system control circuit 206 determines that the likelihood is high.

In step S1604, the system control circuit 206 estimates the image region of the object based on the position of each particle having a higher likelihood (see FIG. 6D).

In step S1605, the system control circuit 206 performs, for the object of which the image region has been estimated in step S1604, preparations for capturing a still image of the object, such as automatic exposure control (AE), auto-focus position control (AF), and automatic white balance control (AWB).

In step S1606, the system control circuit 206 adaptively arranges a particle having a lower likelihood in the position of a particle having a higher likelihood (i.e., performs re-sampling processing, see FIG. 6E).

The operation to change the dispersion of the normal distribution to be performed in step S1602 will be described in detail below with reference to FIGS. 17A and 17B.

As illustrated in FIG. 6A, it is assumed here that the tracking operation starts from the central portion 602 of the captured image and all the particles are moved in the central portion 602 as the initial arrangement of step S404. Each of FIGS. 17A and 17B illustrates particles having moved from the central portion 602 in step S1602. Each of the particles is moved from the previous particle position (i.e., the central portion 602 in the initial arrangement) according to the random number following the normal distribution.

In many cases, the object to be tracked tends to move horizontally when it is displayed on the screen. In other words, except for a bird's-eye view image that is captured from a higher place, the object usually moves two-dimensionally on the ground and is captured by a camera from the side. When the image of the object moving two-dimensionally on the ground is captured by a camera from the side, the object mainly moves in the horizontal direction when it is displayed on the screen. Therefore, the moving range of the particles has a horizontally elongated shape.

Therefore, as illustrated in FIG. 17A, in a case where the camera is horizontally positioned, the X-coordinate of a movement destination in the screen changes according to a random number following a normal distribution 1701 whose dispersion is large. The Y-coordinate of the movement destination changes according to a random number following a normal distribution 1702 whose dispersion is small. Therefore, the distribution of the particles has an elliptic shape extending in the horizontal direction as illustrated in FIG. 17A.

On the other hand, as illustrated in FIG. 17B, in a case where the camera is vertically positioned, the X-coordinate of a movement destination in the screen changes according to a random number following a normal distribution 1703 whose dispersion is small. The Y-coordinate of the movement destination changes according to a random number following a normal distribution 1704 whose dispersion is large. Therefore, the distribution of the particles has an elliptic shape extending in the horizontal direction as illustrated in FIG. 17B.

In the present exemplary embodiment, the angle sensor 1401 is additionally provided to detect the camera posture. Alternatively, the imaging apparatus may be configured to detect the camera posture by analyzing an image obtained by the image sensor 111.

Next, an eighth exemplary embodiment will be described. An output of the AE sensor 203 may include information not relating to the object image. For example, the sensor itself may include a defective pixel. Further, AF distance measurement frames are displayed on a viewfinder screen. Therefore, if a particle is arranged in the position of such information as a result of the random movement of the particle according to a random number following the normal distribution, tracking information cannot be obtained accurately and the accuracy of the tracking operation deteriorates.

According to the eighth exemplary embodiment, the imaging apparatus can randomly move the particles according to a random number following the normal distribution so as to prevent the particles from being arranged in a pixel not suitable for obtaining the tracking information.

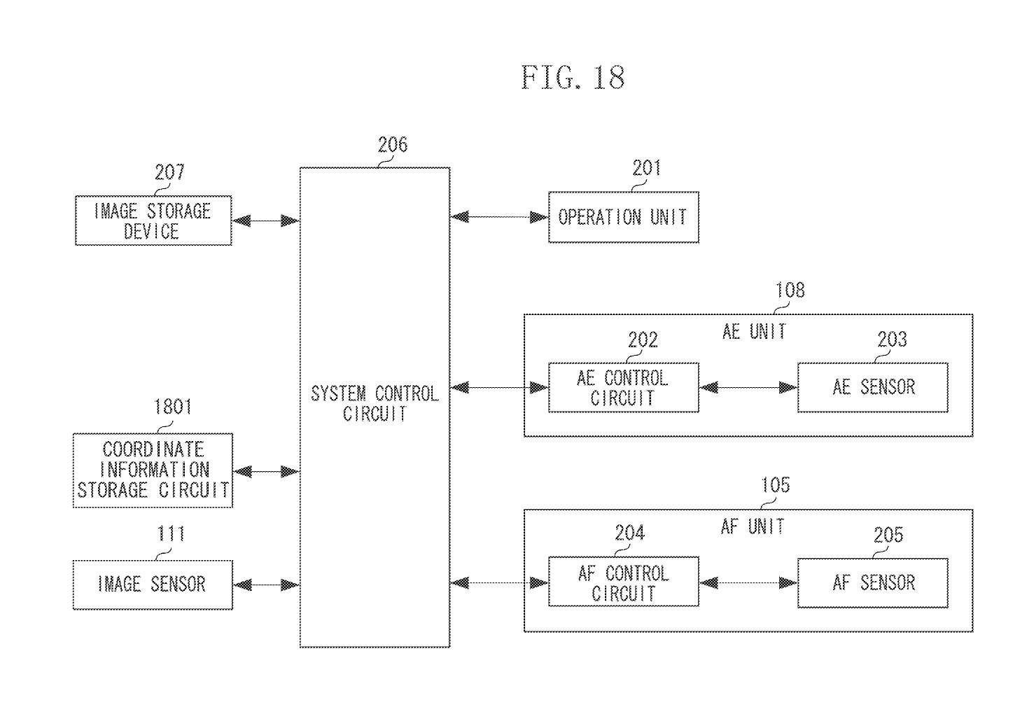

FIG. 18 illustrates a configuration of an imaging apparatus according to the eighth exemplary embodiment. The imaging apparatus illustrated in FIG. 18 is different from the apparatus illustrated in FIG. 2 in that a coordinate information storage circuit 1801 is additionally provided. The coordinate information storage circuit 1801 stores coordinate information of each defective pixel of the AE sensor 203, and information of coordinates corresponding to each AF distance measurement frame of the viewfinder on the focusing screen 106. Constituent components similar to those illustrated in FIGS. 1 and 2 are denoted by the same reference numerals and redundant description thereof will be avoided. Further, the imaging apparatus according to the eighth exemplary embodiment performs shooting operations that are similar to those described in the first exemplary embodiment. The eighth exemplary embodiment is different from the first exemplary embodiment in the operation of the object tracking processing, which will be mainly described below.

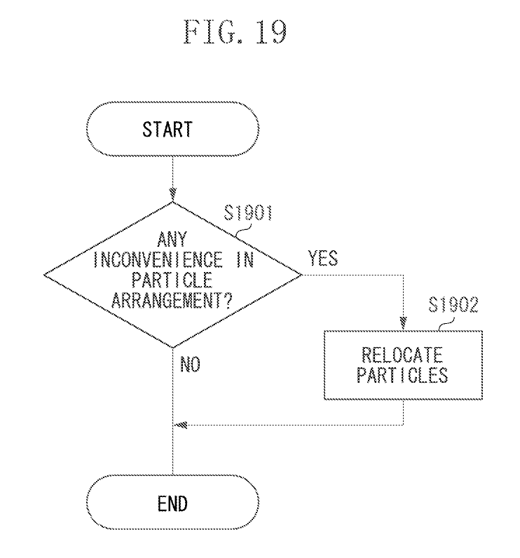

FIG. 19 is a flowchart illustrating details of the processing for randomly moving the particles (e.g., step S501 in FIG. 5 and step S703 in FIG. 7) according to the eighth exemplary embodiment.

The system control circuit 206 randomly moves the particles according to the random number following the normal distribution (see FIG. 6C). In this case, in step S1901, the system control circuit 206 checks the arrangement of the particles for inconveniences. More specifically, the system control circuit 206 compares the coordinate information of each defective pixel and each AF frame stored in the coordinate information storage circuit 1801 with the coordinates of each of the randomly-arranged particles. If the system control circuit 206 determines that there is an overlapping portion (YES in step S1901), then in step S1902, the system control circuit 206 rearranges the particle having caused the inconvenience. In performing the relocation, the system control circuit 206 moves the particle from the overlapping portion to the nearest position where no inconvenience occurs. For example, in a case where a particle overlaps with the upside line of an AF distance measurement frame, the system control circuit 206 moves the particle upward to a position where the particle does not overlap with the AF distance measurement frame. Further, in a case where a particle overlaps with the right-hand line of an AF distance measurement frame, the system control circuit 206 moves the particle rightward to a position where the particle does not overlap with the AF distance measurement frame.

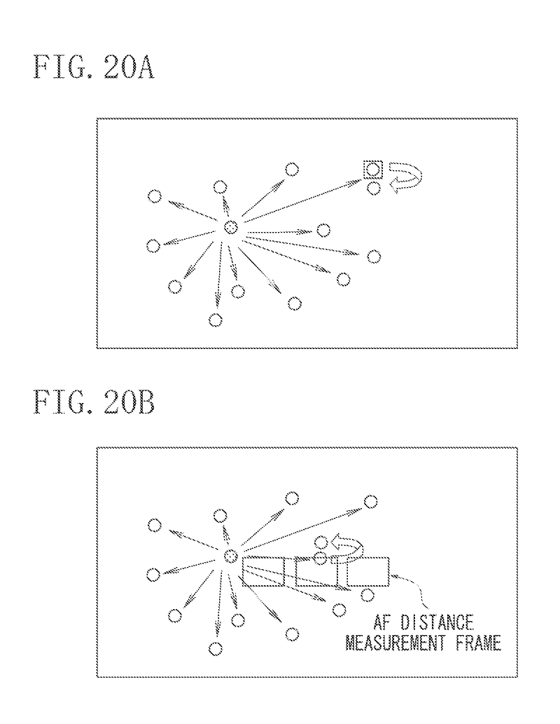

FIGS. 20A and 20B illustrate examples of the particle relocation. FIG. 20A illustrates a particle overlapping with a defective pixel. In such a case, the system control circuit 206 rearranges the particle so as to avoid the overlap. The defective pixel in this case is, for example, a complementary metal-oxide semiconductor (CMOS) defective pixel, an imaging plane phase difference AF pixel, or an infrared (IR) pixel. Further, FIG. 20B illustrates a particle overlapping with an upside line of an AF distance measurement frame. In this case, the system control circuit 206 rearranges the particle to an upper position that does not cause the particle to overlap with the AF distance measurement frame.

By performing the above-described operation, highly-accurate tracking calculation is realized without any adverse influence of a defective pixel or an AF distance measurement frame.

Although the coordinate information of both the defective pixel and the AF distance measurement frame is used, only one of them may be used in the present exemplary embodiment.

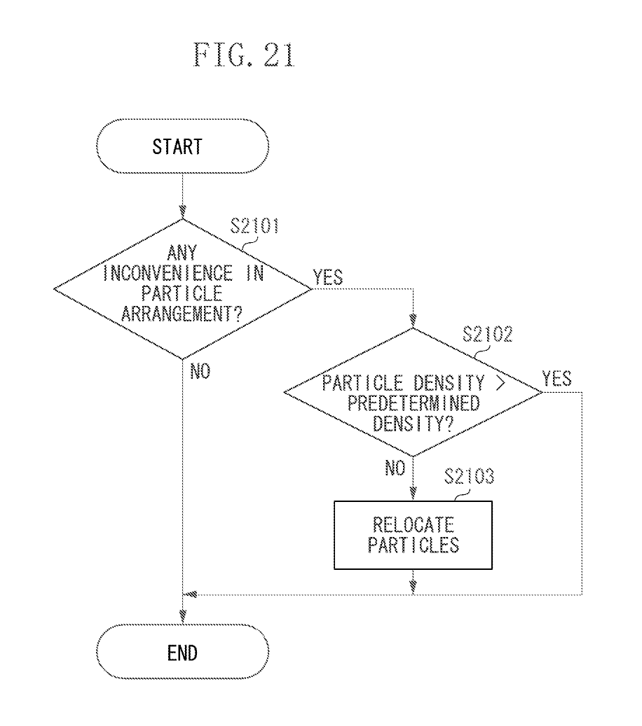

FIG. 21 illustrates a modification example of the processing for randomly moving the particles.

The system control circuit 206 randomly moves the particles according to the random number following the normal distribution (see FIG. 6C). In this case, in step S2101, the system control circuit 206 checks the arrangement of the particles for inconveniences. More specifically, the system control circuit 206 compares the coordinate information of each defective pixel and each AF frame stored in the coordinate information storage circuit 1801 with the coordinates of each of the randomly-arranged particles. If the system control circuit 206 determines that there is an overlapping portion (YES in step S2101), then in step S2102, the system control circuit 206 determines whether the particle density in a peripheral region adjacent to the overlapping portion is greater than a predetermined density. If the system control circuit 206 determines that the peripheral particle density is greater than the predetermined density (YES in step S2102), the system control circuit 206 terminates the processing of the flowchart illustrated in FIG. 21. If the system control circuit 206 determines that the peripheral particle density is equal to or less than the predetermined density (NO in step S2102), then in step S2103, the system control circuit 206 rearranges the particle having caused the inconvenience, similarly to step S1902 illustrated in FIG. 19. The system control circuit 206 performs the relocation only when the peripheral particle density is equal to or less than the predetermined density, in order to reduce the number of particles to be rearranged. In a case where the particle density is greater than the predetermined density, it is not necessary for the system control circuit 206 to perform the relocation because calculation information of an adjacently-arranged particle is available for the tracking calculation. Thus, the above-described processing produces the effect of reducing the processing time required to perform the relocation.

### Modification Example

In each of the above-described exemplary embodiments, the imaging apparatus performs the object tracking by using the light metering image data obtained by the AE unit 108. However, as another example, the imaging apparatus may perform the object tracking by using image data obtained by the high-resolution image sensor 111. By performing such an operation, a small object can be tracked using a high-resolution image although the calculation amount relatively increases.

Further, in each of the above-described exemplary embodiments, the imaging apparatus specifies the object positioned at the center of the light metering image data as a tracking target (see step S403). However, as another example, a photographer may be requested to input an object to be tracked via an operation. Further, a face detection unit may be additionally provided so that the imaging apparatus can track a detected face with a higher priority to enhance face-tracking capability.

Further, in each of the above-described exemplary embodiments, the imaging apparatus performs the tracking operation based on the characteristic color of a target object, and calculates likelihood based on similarity in color. However, as another example, the imaging apparatus may perform the tracking operation based on luminance, color difference, or color saturation of an object image, and calculate likelihood based on similarity in any one of luminance, color difference, and color saturation.

The above-described exemplary embodiments of the present invention can also be realized by performing the following processing. A program capable of realizing at least one of the functions of the above-mentioned exemplary embodiments is supplied to a system or an apparatus via a network or an appropriate storage medium, and at least one processor of a computer provided in the system or the apparatus reads and executes the program. Further, the exemplary embodiments of the present invention can also be realized by a circuit (e.g., an application specific integrated circuit (ASIC) capable of realizing at least one of the functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-183341, filed Sep. 9, 2014, which is hereby incorporated by reference herein in its entirety.

What is claimed is:

1. An image processing apparatus comprising:
an object tracking unit configured to use particle filter processing to perform object tracking processing in which the object tracking unit repeatedly performs distributing particles on an image, calculating an evaluation value at a position of each of the particles to estimate an image region of an object, and arranging a particle having a lower evaluation value in a position of a particle having a higher evaluation value,
wherein the object tracking unit is configured to change a way of distributing the particles according to a change in the object or a state of an imaging apparatus having captured the image.

2. The image processing apparatus according to claim 1, wherein the object tracking unit is configured to increase a distribution range of the particle in a case where a movement amount of the object to be tracked is equal to or greater than a threshold value compared to a case where the movement amount is less than the threshold value.

3. The image processing apparatus according to claim 1, wherein the object tracking unit is configured to increase a distribution range of the particles as a movement amount of the object to be tracked becomes larger.

4. The image processing apparatus according to claim 1, wherein the object tracking unit is configured to increase a distribution range of the particles in a case where a moving speed of the object to be tracked is equal to or greater than a threshold value compared to a case where the moving speed is less than the threshold value.

5. The image processing apparatus according to claim 1, wherein the object tracking unit is configured to increase a distribution range of the particles as a moving speed of the object to be tracked becomes higher.

6. The image processing apparatus according to claim 1, wherein the object tracking unit is configured to increase a distribution range of the particles in a case where an area of the object to be tracked is equal to or greater than a threshold value compared to a case where the area is less than the threshold value.

7. The image processing apparatus according to claim 1, wherein the object tracking unit is configured to increase a distribution range of the particles as an area of the object to be tracked becomes larger.

8. The image processing apparatus according to claim 1, wherein the object tracking unit is configured to increase a distribution range of the particles as a focal length of an optical system used to capture the image becomes longer.

9. The image processing apparatus according to claim 1, wherein the object tracking unit is configured to increase a distribution range of the particles as a distance from the imaging apparatus having captured the image to the object becomes closer.

10. The image processing apparatus according to claim 1, wherein the object tracking unit is configured to increase a distribution range of the particles in a case where an angular velocity or an acceleration of the imaging apparatus having captured the image is equal to or greater than a threshold value compared to a case where the angular velocity or the acceleration is less than the threshold value.

11. The image processing apparatus according to claim 1, wherein the object tracking unit is configured to increase a distribution range of the particles as an angular velocity or an acceleration of the imaging apparatus having captured the image becomes larger.

12. The image processing apparatus according to claim 1, wherein the object tracking unit is configured to increase a distribution range of the particles in a case where an ISO sensitivity set for the imaging apparatus having captured the image is less than a threshold value, compared to a case where the ISO sensitivity is equal to or greater than the threshold value.

13. The image processing apparatus according to claim 1, wherein the object tracking unit is configured to increase a distribution range of the particles as an ISO sensitivity set for the imaging apparatus having captured the image becomes lower.

14. The image processing apparatus according to claim 1, wherein the object tracking unit is configured to change a distribution range of the particles according to a posture of the imaging apparatus having captured the image in such a manner that the distribution range of the particles is long in a horizontal direction relative to a ground.

15. The image processing apparatus according to claim 1, wherein, in a case where a part of the distributed particles overlaps with at least one of a position of a defective pixel included in an image sensor used to capture the image and a position of a distance measurement frame of the imaging apparatus having captured the image, the object tracking unit is configured to move a position of the overlapping particle.

16. An imaging apparatus comprising:
an image sensor configured to generate an image;
an object tracking unit configured to use particle filter processing to perform object tracking processing in which the object tracking unit repeatedly performs distributing particles on the image, calculating an evaluation value at a position of each of the particles to estimate an image region of an object, and arranging a particle having a lower evaluation value in a position of a particle having a higher evaluation value,
wherein the object tracking unit is configured to change a way of distributing the particles according to a change in the object or a state of the imaging apparatus.

17. An image processing method comprising:
using particle filter processing to perform object tracking processing in which distributing particles on an image, calculating an evaluation value at a position of each of the particles to estimate an image region of an object, and arranging a particle having a lower evaluation value in a position of a particle having a higher evaluation value are repeatedly performed,
wherein in the object tracking processing, a way of distributing the particles is changed according to a change in the object or a state of an imaging apparatus having captured the image.

18. A non-transitory computer-readable storage medium which stores a program for causing a computer to execute the image processing method according to claim 17.
